(19) United States
(12) Patent Application Publication
(10) Pub. No.: US 2008/0147461 A1
(43) Pub. Date: Jun. 19, 2008

(54) METHODS AND APPARATUS TO MONITOR CONSUMER ACTIVITY

(76) Inventors: Morris Lee, Palm Harbor, FL (US); Arun Ramaswamy, Tampa, FL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/957,227

(22) Filed: Dec. 14, 2007

Related U.S. Application Data
(60) Provisional application No. 60/870,045, filed on Dec. 14, 2006.
(60) Provisional application No. 60/981,328, filed on Oct. 19, 2007.

(51) Int. Cl. G06Q 10/00; G06Q 30/00; G01S 1/00

(52) U.S. Cl. 705/7; 705/14; 705/1; 342/453; 342/464

(57) ABSTRACT

Methods and apparatus to monitor consumer activity are disclosed herein. In a disclosed example method, a first signal is received via a portable device from a first one of a plurality of stationary devices positioned throughout a monitored environment. A first stationary device location of the first stationary device is determined based on the first signal. Absolute location information indicative of a first portable device location of the portable device is determined based on the first stationary device location. Navigational sensing information is generated by the portable device. Relative location information is determined based on the absolute location information and the navigational sensing information, wherein the relative location information is indicative of a second portable device location of the portable device.

### RELATED APPLICATIONS

This patent claims the benefit of U.S. Provisional Patent Application No. 60/870,045, filed Dec. 14, 2006, and U.S. Provisional Patent Application No. 60/981,328, filed Oct. 19, 2007, both of which are hereby incorporated herein by reference in their entireties.

### FIELD OF THE DISCLOSURE

The present disclosure relates generally to media monitoring and, more particularly, to methods and apparatus to monitor consumer activity.

### BACKGROUND

Retail establishments and product manufacturers are often interested in the shopping activities, behaviors, and/or habits of people in a retail environment. Consumer activity related to shopping can be used to correlate product sales with particular shopping behavior and/or to improve placements of products, advertisements, and/or other product-related information in a retail environment. Known techniques for monitoring consumer activities in retail establishments include conducting surveys, counting patrons, and/or conducting visual inspections of shoppers or patrons in the retail establishments. However, such known techniques have drawbacks that can skew or adversely impact any derived analytic data. For example, consumer surveys rely on consumers being accurate in their responses to survey questions. However, consumers often inadvertently miss or forget information that may be relevant to particular survey questions and provide responses that are not completely accurate or representative of their activities or behaviors in connection with patronizing retail establishments.

Known techniques used to count patrons in retail establishments can also have drawbacks. For example, patron counts can be used to determine the number of people present in a retail establishment or in areas of a retail establishment at any one time, but cannot be used to accurately access the activities or behaviors of those people while patronizing the retail establishment. Also, known techniques used by research personnel to visually inspect retail establishments to record or log consumer or patron activities in those retail establishments can produce inaccurate results due to the subjective nature of human beings in the roles of research personnel. For example, one research person performing a visual inspection of a scenario may log events associated with that scenario quite differently from how another research person might log the events when observing the exact same scenario. Further, data generated or logged by research personnel is prone to human error, which can adversely affect or skew any derived analytic data.

### BRIEF DESCRIPTION OF THE DRAWINGS

FIG. 1 illustrates an example indoor environment having a location determination system including a plurality of stationary location devices installed throughout the example indoor environment to enable determining locations of tags as the tags are moved within the indoor environment.

FIG. 2 is a detailed block diagram of the example tags of FIG. 1.

FIG. 3 is an example location determination system that may be used to implement the location determination system of FIG. 1.

FIGS. 4A-4C depict a flow diagram illustrating an example method that may be used to configure the example location determination system of FIGS. 1 and 3 and use the location determination system to generate location information indicative of the locations traversed by persons in the monitored environment of FIG. 1.

FIG. 5 is a flow diagram representative of machine readable instructions that can be executed to implement the tags of FIGS. 1 and 2 to generate shopper monitoring information as persons move through the example indoor environment of FIG. 1.

FIGS. 6A and 6B depict a flow diagram representative of machine readable instructions that can be executed to implement the tags of FIGS. 1 and 2 to generate shopper monitoring information as persons move through the example indoor environment of FIG. 1.

FIG. 7 is a flow diagram representative of machine readable instructions that can be executed to process shopper monitoring information collected by tags in the monitored environment of FIG. 1.

FIG. 8 is a flow diagram representative of machine readable instructions that can be executed to determine absolute locations of persons in the monitored environment of FIG. 1.

FIG. 9 is a flow diagram representative of machine readable instructions that can be executed to determine absolute locations of a person in the monitored environment of FIG. 1.

FIGS. 10A and 10B are diagrams illustrating comparisons of paths generated using a dead reckoning process and actual paths traversed by a person carrying a tag having a dead reckoning system.

FIG. 11 illustrates barcode labels that can be used to identify tags carried by shoppers in the monitored environment of FIG. 1.

FIG. 12 is a detailed block diagram of an example point of service system of FIGS. 1 and 11.

FIG. 13 illustrates a tag check-in system and a docking system that can be used to receive tags returned by shoppers at the end of their shopping trips.

FIGS. 14A and 14B illustrate an example docking station to communicatively couple tags with a system used to receive shopper monitoring information collected by the tags.

FIGS. 15 and 16 illustrate how toroid-shaped tags can be placed on the docking station of FIGS. 14A and 14B.

FIG. 17 depicts another example implementation of the example docking station of FIGS. 14A, 14B, 15, and 16.

FIG. 18 depicts a portion of the monitored environment of FIG. 1 having an actual path of travel and a calculated path of travel overlaid thereon.

FIG. 19 is a block diagram of an example processor system that may be used to implement some or all of the example methods and apparatus described herein.

### DETAILED DESCRIPTION

Although the following discloses example methods, apparatus, and systems including, among other components, software executed on hardware, it should be noted that such methods, apparatus, and systems are merely illustrative and should not be considered as limiting. For example, it is contemplated that any or all of these hardware and software components could be embodied exclusively in hardware, exclusively in software, or in any combination of hardware and software. Accordingly, while the following describes example methods, apparatus, and systems, the examples provided are not the only way to implement such methods, apparatus, and systems.

The example methods and apparatus described herein may be used to monitor consumer activity to determine consumer exposure to media sources, media presentations, products, advertisements, etc. as consumers walk through a monitored environment. For example, the example methods and apparatus described herein may be implemented in connection with a retail establishment to generate location information indicative of the locations traveled by consumers as the consumers shopped in the retail establishment. The location information can then be used to identify and credit media sources, media presentations, products, advertisements, etc. to which the consumers were exposed as they walked through the retail establishment. Retail establishments and product manufacturers are often interested in the shopping behavior or shopping habits of people when those people walk through a retail environment. Shoppers' exposure to media sources, media presentations, products, advertisements, and/or other product-related information can often influence shopping behavior. The example methods and apparatus described herein can be used to collect shopper exposure information which can then be correlated with shopping behavior and/or product sales to improve product placement, advertisement placement, marketing campaigns, etc. in retail environments.

As discussed below, the example methods and apparatus described herein may also be used to increase the accuracy associated with determining location information indicative of the locations of consumers when the consumers move through a monitored environment such as, for example, a retail establishment. In particular, a dead reckoning device or module in a portable tag (e.g., a carryable or wearable tag) can be used in connection with location signal emitting anchor units (e.g., stationary location devices, signal emitters, etc.) located throughout a monitored environment to generate relatively more accurate location information and path of travel information than using the dead reckoning module alone or the location signal emitting anchor units alone.

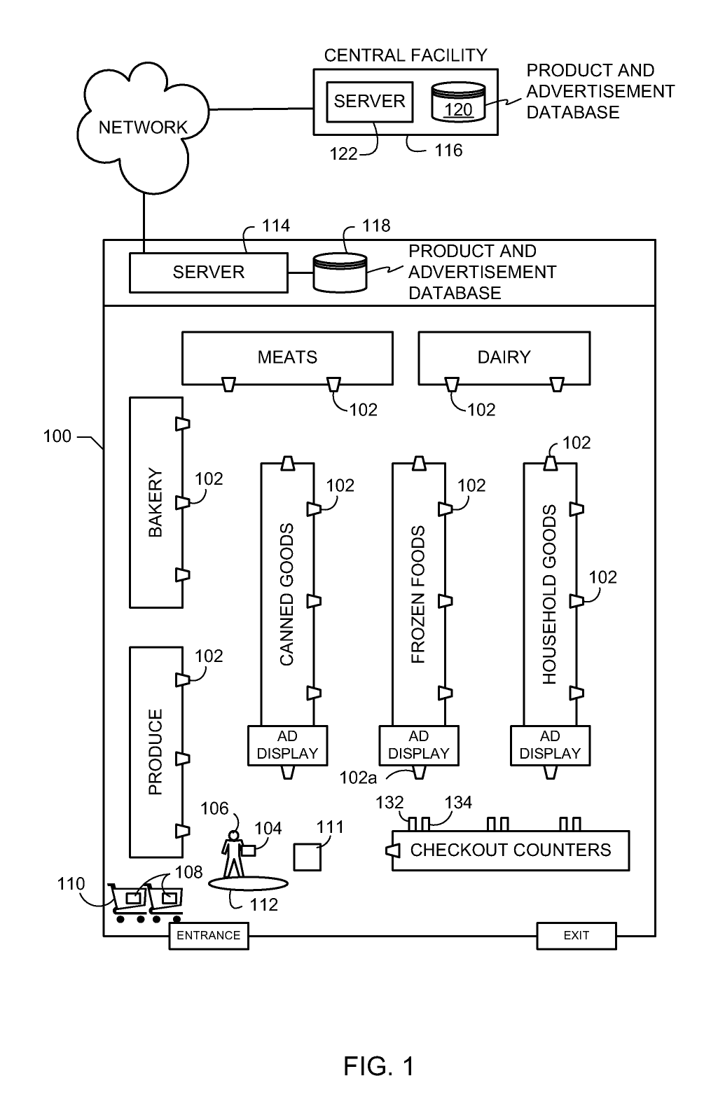

Turning to FIG. 1, an example indoor environment 100 (e.g., a monitored environment) includes a location determination system including a plurality of stationary location devices 102 (e.g., signal emitters or signal receivers) installed throughout the example indoor environment 100 to enable determining a location of a tag 104 as the tag 104 is moved through the indoor environment 100. The location determination system of FIG. 1 is configured to track the location of the tag 104 in different types of environments. In some example implementations, the location determination system of FIG. 1 can also be configured to determine particular products, advertisements, and/or information to which people were exposed as they moved through the example indoor environment 100. In the illustrated example, the location determination system of FIG. 1 is implemented in a commercial establishment or environment to generate information indicative of locations within the commercial establishment visited by patrons of the commercial establishment. In the illustrated example, although the indoor environment 100 is a retail environment, the example methods, apparatus, and systems described herein may be implemented in any other types of commercial establishments including wholesale establishments, restaurants, entertainment establishments, etc.

In the illustrated example, the tag 104 may be carried by a person 106 so that location information generated by the tag 104 will be indicative of the locations traversed by the person 106 as the person 106 moved through the monitored environment 100. Additionally or alternatively, tags 108 substantially similar or identical to the tag 104 may be mounted to shopping carts 110 or shopping baskets (not shown). In this manner, a person that uses a shopping cart 110 or a shopping basket while moving through the monitored environment 100 (e.g., while shopping), need not carry a separate tag. Tags (e.g., the tag 104 or the shopping carts 110 including the tags 108) may be handed out (e.g., loaned) to patrons of a retail establishment (e.g., the example indoor environment 100) when the patron(s) enter the retail establishment and consent to participating in a market research program. The patrons can then turn in their tags 104 and/or 108 prior to leaving the retail establishment. Alternatively or additionally, the location determination system of FIG. 1 may be configured to work with tags carried by persons outside the example indoor environment 100 and that work with other location systems (e.g., tower-transceiver based location systems, global positioning systems (GPS) based location systems, etc.). In some example implementations, each of the tags 104 and 108 may be implemented using a small housing having a form-factor similar to a credit card. In other example implementations, each of the tags 104 and 108 may be implemented using a portable meter, which may be relatively larger and/or have relatively more functionality. As described below in connection with FIGS. 14A, 14B, 15, and 16, each of the tags 104 and/or 108 can be implemented using a toroid-shaped housing, a toroid-shaped form-factor or a toroid-shaped body.

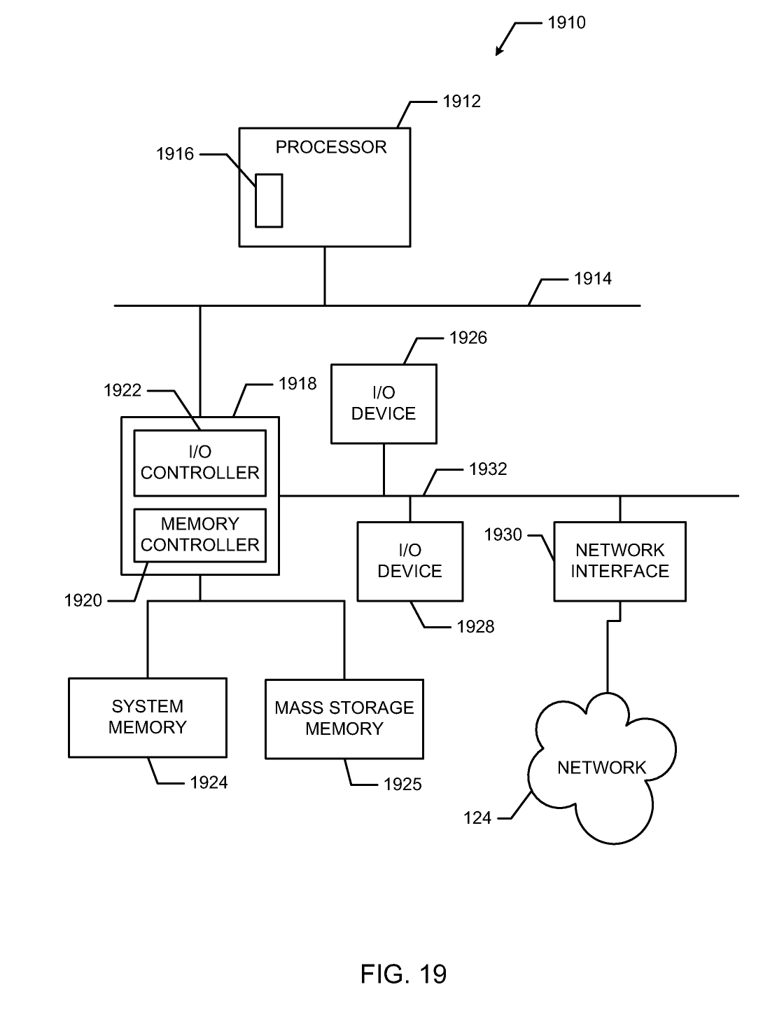

In the illustrated example, to collect demographic or other personal information, personal preference information, or descriptive information corresponding to patrons (e.g., the person 106), a point of service system 111 is located near an entrance of the indoor environment 100. The point of service system 111 may be implemented using a processor system (e.g., the processor system 1910 of FIG. 19) and may be implemented as a portable device (e.g., a personal digital assistant (PDA), a handheld computer, a laptop, a tablet computer, etc.) or a stationary system (e.g., a kiosk or a desktop terminal). In the illustrated example, the point of service system 111 is configured to store demographic and/or other information entered by a market research person (not shown) that issues or hands out the tags 104 and/or 108 to patrons. For example, after the person 106 consents to participating in a market research program, the market research person can ask the person 106 whether the person is willing to answer some questions to gather personal information about the person including, for example, demographic and/or other information. If the person 106 consents to provide the personal information, the market research person can enter the demographic/personal information into the point of service system 111. In some example implementations, if the person 106 does not consent to provide the personal information, the market research person may instead enter other basic characteristic information that is descriptive and/or readily apparent information about the person such as, for example, whether the person is shopping alone or with another person, whether the person is male or female, and/or other information readily ascertainable using visual observance.

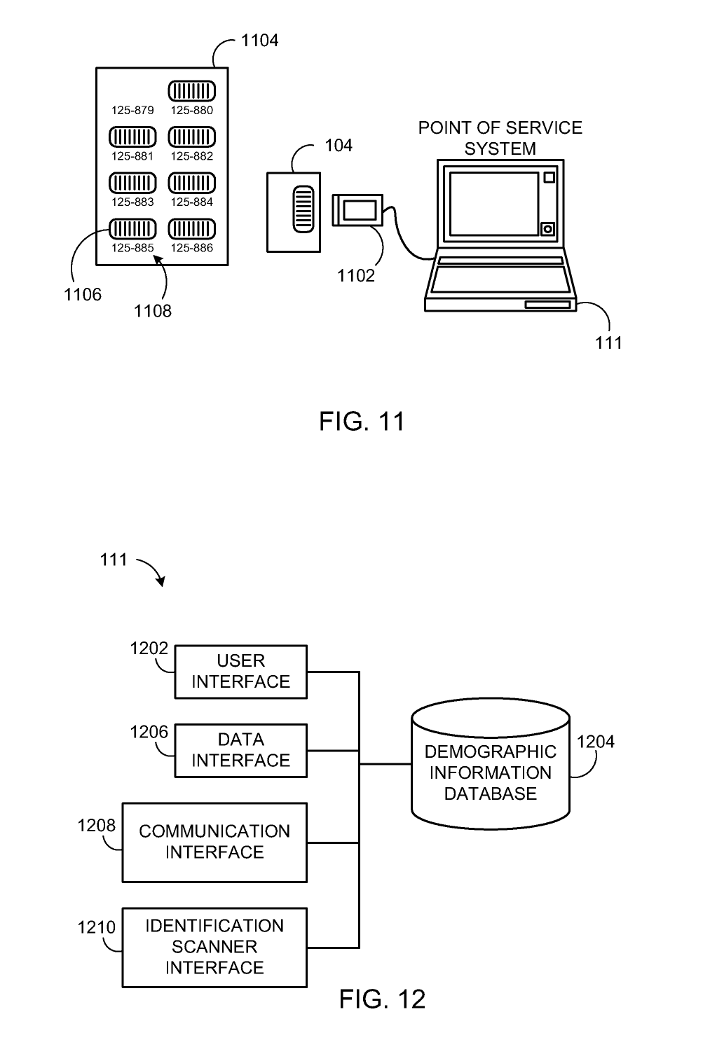

In the illustrated example, the point of service system 111 may be configured to store the demographic information about the person 106 in association with an identifier (e.g., an identification number) of the tag 104 or 108 issued or handed to the person 106. Additionally or alternatively, the point of service system 111 can communicate or download, via wired or wireless communications, the personal or descriptive information to the tags 104 and/or 108 when they are issued to patrons. Referring to FIG. 11, in some example implementations, the point of service system 111 is provided with a barcode scanner 1102, and the tags 104 and 108 are provided with barcodes indicating their identification numbers. The point of service system 111 can obtain the identification of the tags 104 and 108 when the market research person uses the barcode scanner 1102 to scan the respective barcodes of the tags 104 and 108. In some example implementations, one or more sheet(s) 1104 of barcode labels 1106 can be placed near the point of service system 111, and the market research person can use the barcode labels 1106 to provide the tags 104 and 108 with a different or unique identification number 1108 each time each of the tags 104 and 108 is loaned to a patron. For example, when a patron consents to participate in a market research program, the market research person can attach a barcode label to a tag, scan the barcode label using the point of service system 111 to establish the identity of the tag, and enter demographic information provided by the patron into the point of service system 111 to be stored in association with the barcode identification number. In alternative example implementations, the tags 104 and 108 can store their respective identifications or identifiers in memory, and the point of service system 111 can obtain the identifications from the tags 104 and/or 108 using wireless or wired communications. As another alternative, electronic ink can be used to print/encode an identifier and/or a label placed on each tag, and the point of service system 111 can be provided with an electronic ink reader to obtain the tag identifications.

Returning to FIG. 1, the point of service system 111 may be configured to download the demographic information or other personal information corresponding to the person 106 to the tag 104. Additionally or alternatively, the point of service system 111 can store and associate the demographic information of the person 106 with the identification of the tag 104 issued to the person 106. In the illustrated example, the point of service system 111 is configured to communicate the demographic/personal information to the server 114. In this manner, when the person 106 returns the tag 104 during checkout, the information collected by the tag 104 can be communicated to the server 114, and the server 114 can store the collected information in association with the demographic/personal information corresponding to the person 106 for subsequent analysis.

In the illustrated example, the point of service system 111 can be configured to communicate with the tags 104 and 108 using any wired or wireless communications. For example, the point of service system 111 and the tags 104 and 108 may be provided with respective wireless communication interfaces (e.g., IEEE 802.11, Bluetooth®, infrared light, a proprietary wireless interface, etc.) that enable the tags 104 and 108 to communicate with the point of service system 111. Alternatively, the point of service system 111 and the tags 104 and 108 can be provided with respective wired communication interfaces (e.g., universal serial bus (USB), RS-232, a proprietary interface, etc.) that enable the tags 104 and 108 to communicate with the point of service system 111.

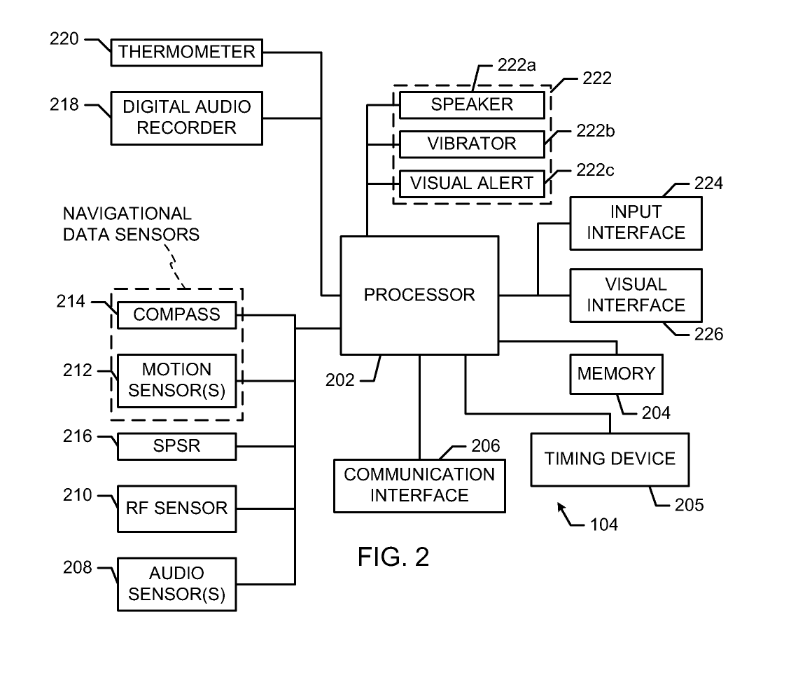

In the illustrated example, the tag 104 (and each of the tags 108) includes one or more location and/or motion sensors, a processor, a communication interface, a memory, and one or more timing devices, each of which may be substantially similar or identical to a respective one of the location and motion sensor(s) 212, the processor 202, the communication interface 206, the memory 204, and the timing device 205 described below in connection with FIG. 2. In addition, each of the tags 104 and 108 can be provided with an audio sensor (e.g., a microphone) configured to detect ultrasonic chirps emitted by the stationary location devices 102 to determine the location of the tag 104 based on information in, and/or signal characteristics of, the ultrasonic chirps.

In the illustrated example, each of the stationary location devices 102 includes a location interface, a processor, a memory, a timing device, and a data transceiver. Preferably, but not necessarily, the location interface is implemented using an ultrasonic signal emitter (e.g., an ultrasonic chirper) that emits ultrasonic chirps that can be detected by the tags 104 and 108. Preferably, but not necessarily, each of the stationary location devices 102 is configured to emit a unique ID assigned to that stationary location device 102 and that can be used to determine the locations of the tags 104 and 108 relative to the stationary location device 102 within the monitored environment 100. For example, a processor of the tag 104 can extract the unique ID embedded in the ultrasonic chirp and use the ID along with characteristic(s) of the received ultrasonic chirp to determine its location within the monitored environment 100 at the time it received the ultrasonic chirp.

Although the stationary location devices 102 are described as emitting ultrasonic chirps, the stationary location devices 102 can alternatively be configured to emit infrared signals (e.g., infrared beam counter signals or infrared proximity signals), ultra-wideband signals, spread spectrum signals, Wi-Fi® signals, Bluetooth® signals, or other radio frequency signals. In some example implementations, the stationary location devices 102 may be configured to emit two types of signals (e.g., an RF signal and an ultrasonic signal or audio signal) that the tags 104 and 108 can use to determine distances from the stationary location devices 102 based on measured propagation delays (e.g., the time of flight delays) of the received signal types and time differences between the propagation delays. For example, RF signals travel faster than ultrasonic signals (or audio signals), and knowing the speed of propagation for each signal, the tag 104 could be configured to determine the distance to a corresponding one of the stationary location devices 102 based on the difference between the times of flight of the RF and ultrasonic signals, a local time of the tag 104, and a timestamp embedded in one or both of the signals by the stationary location device indicative of when the stationary location device emitted the signals.

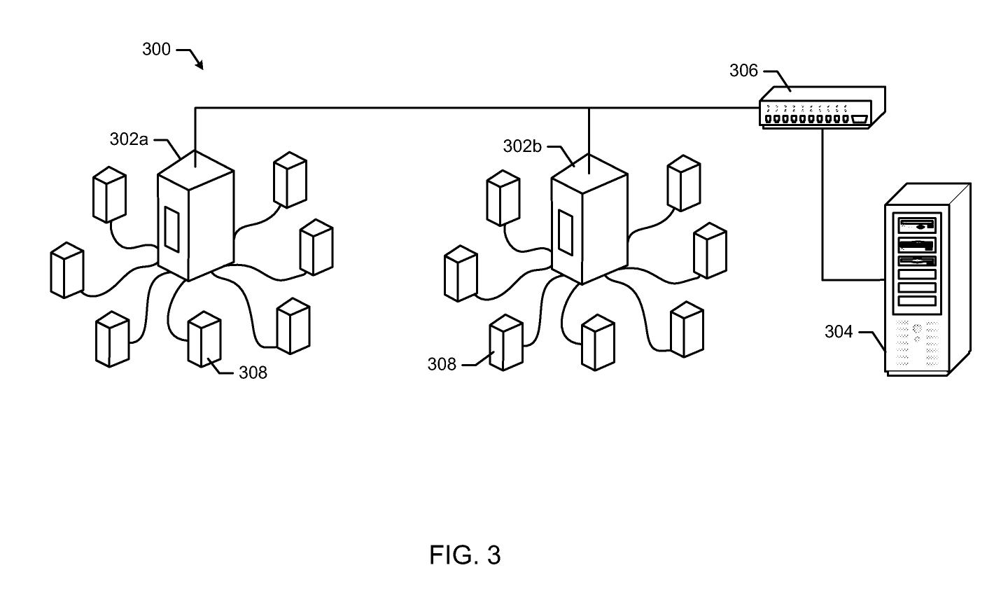

In some example implementations, the tags 104 and 108 can instead be configured to emit chirps or other signals and the stationary location devices 102 can instead be implemented using signal receivers that detect the chirps emitted by the tags 104 and 108. In this manner, location detection processing described below can be performed by the signal receivers (or a central processing unit coupled to the signal receivers) instead of the tags 104 and 108. The example system described below in connection with FIG. 3 could be used to implement a location detection system in which the tags 104 and 108 emit chirps and stationary signal receivers located throughout the environment 100 detect the chirps.

Preferably, but not necessarily, the tags 104 and 108 are configured to perform dead reckoning processes to determine their respective locations within the monitored environment 100. A dead reckoning location determination process can be implemented using a compass (e.g., the compass 214 of FIG. 2) and one or more motion sensors (e.g., the motion sensor(s) 212 of FIG. 2). In some example implementations, the dead reckoning location determination process can also be implemented in connection with a global positioning system receiver (e.g., the SPS receiver 26 of FIG. 2). An example dead reckoning device that can be implemented in each of the tags 104 and 108 is the Dead-Reckoning Module (DRM®) produced and sold by Honeywell International Inc. of Morristown, N.J. The DRM® is configured to enable generation and/or collection of location information within buildings (e.g., the monitored environment 100) and in outdoor environments.

To determine a position of a tag using a dead reckoning system, the dead reckoning system is provided with an initial known position of the tag (e.g., an absolute location of the tag relative to a monitored environment, a geographic positioning system, etc.). Example dead reckoning systems may be implemented using devices that generate navigational sensing information such as, for example, inertia-sensing devices, magnetic field sensing devices, gyroscopic devices, etc. Such devices may include a compass (e.g., the compass 214 of FIG. 2) to determine the direction in which a person is traveling, an accelerometer (e.g., one of the motion sensor(s) 212 of FIG. 2) to detect acceleration, and a gyroscope (e.g., one of the motion sensor(s) 212) to detect movement and/or motion to compute a new position relative to a previous position or an estimate of a previous position. That is, a dead reckoning process can be used to determine that a tag has been moved by a particular amount with respect to a known earlier position based on direction, acceleration, and/or motion information generated by the compass, the accelerometer and/or the gyroscope. Position information generated using dead reckoning techniques is only as accurate as a previously provided or determined position, because the dead reckoning techniques determine relative location information based on previously determined or obtained location information. Nevertheless, dead reckoning systems are useful because, after receiving initial location information, they do not depend on the subsequent receipt of external information (e.g., location ID's or location information received from external systems or devices), but instead, they depend on stimuli that is readily available such as, for example, the Earth's magnetic field as measured by compasses and a person's generated motion as measured by the accelerometers and/or gyroscopes. Thus, dead reckoning systems can be used to determine location information of the tags 104 and 108 in environments (e.g., indoor environments) in which location information such as GPS signals are not readily available.

In the illustrated example of FIG. 1, to determine its location, the dead reckoning device of the tag 104 is provided with an initial known location (e.g., an absolute location) of the tag 104. The dead reckoning location determination process can then generate subsequent location information (e.g., relative location) based on direction, acceleration, and/or motion information generated by the compass, the accelerometer and/or the gyroscope. In the illustrated example of FIG. 1, the tag 104 can be set to the initial location indicated by reference numeral 112 by, for example, pressing a ‘set’ button on the tag 104 that resets its location to the initial location 112 while the tag 104 is located at the initial location 112. Alternatively, a tag provided with a GPS receiver may use the last known location determined outside the monitored environment 100 based on GPS signals received from GPS satellites.

After being set to or otherwise receiving an initial known location (e.g., the initial location 112), the tag 104 of the illustrated example uses a dead reckoning process to determine its subsequent locations as it is moved through the monitored environment 100. However, such estimated location information (e.g., relative location information) is often susceptible to drift or error due to, for example, inertial drift caused by a person's sudden movements (e.g., sudden stops) and the inability of an accelerometer and/or gyroscope to recognize that some of their generated signals are due to inertia after a person has actually stopped moving. Thus, over time, the location information calculated using dead reckoning processes can include errors or inaccuracies. When using location information having such inaccuracies for marketing research associated with retail environments having relatively small distances between products, advertisements, or information of interest, the location inaccuracies can skew, reduce the usefulness and/or even invalidate the measured results. In the case of severe error, location data may actually reflect that the person was walking down a completely separate (e.g., an adjacent) aisle of the store from the aisle that was actually traversed.

To substantially eliminate or reduce the above-noted errors associated with unmodified dead reckoning-based location information, the location determination system of FIG. 1 is configured to use the stationary location devices 102 as anchor points that enable the tags 104 and 108 to determine absolute location information when possible to improve or increase the degree of accuracy associated with determining their respective locations within the monitored environment 100. For example, the stationary location devices 102 periodically emit one or more ultrasonic chirps, and each of the stationary location devices 102 embeds its unique ID in its ultrasonic chirps. As the tag 104 is moved through the monitored environment 100, the tag 104 detects (e.g., receives) the ultrasonic chirp(s) via an audio sensor. The tag 104 is configured to measure and store signal characteristics (e.g., signal strength, volume, etc.) of the ultrasonic chirp(s) and extract the unique ID's from the received signal(s). To improve the accuracy of the location information generated using a dead reckoning process, the tag 104 can periodically (or aperiodically) determine absolute location information based on the received ultrasonic chirps. In this manner, subsequent relative location information determined using dead reckoning processes can be generated based on the absolute location information. The absolute location information may be generated using, for example, triangulation techniques, look-up table techniques, etc. The absolute location information effectively provides a vehicle for correcting the drift noted above as problematic in unimproved dead reckoning systems.

In more detail, the unique ID's in the ultrasonic chirps can include location information (e.g., location coordinates), or the tag 104 can be configured to store a data structure that associates the unique ID's of the stationary location devices 102 in the environment 100 with location information (e.g., location coordinates) indicative of the locations of the stationary location devices 102 in the environment 100. In some example implementations, a server 114 and/or a server 122 at a central collection facility 116 can store a data structure that associates the unique ID's of the stationary location devices 102 in the environment 100 with location information indicative of their respective locations and can be used to post process the data (e.g., the unique ID's, the signal characteristics, the recorded audio chirps, etc.) collected by the tags 104 and 108.

In some instances, to determine an absolute location of the tag, the tag 104 can simultaneously detect ultrasonic chirps from one or more of the stationary location devices 102, compare the strengths (e.g., volume or signal strength) of the received chirps, and select one or more of the chirps having the strongest signal strength. The tag 104 (and/or the server 114) can then extract the unique ID from the strongest chirp and determine a current absolute location of the tag 104 within the environment 100 based on the unique ID. For example, the tag 104 (and/or the server 114) can extract location coordinates from the received chirp or retrieve location coordinates from a data structure based on the unique ID or other unique signal characteristic. In the illustrated example, the tag 104 can use a timer (e.g., the timing device 205 of FIG. 2) to determine how often to collect chirp information and/or dead-reckoning-related information. In some example implementations, the tag 104 may be configured to not generate relative location information or absolute location information. Instead, the tag 104 can merely collect and store dead-reckoning-related information (e.g., direction information, accelerometer information, gyroscope information, etc.) and chirp signals or information from chirps received from the stationary location devices 102. Subsequently, the server 114 can generate absolute location information based on the stored chirp information and relative location information using dead reckoning processes based on the stored dead-reckoning-related information and the absolute location information.

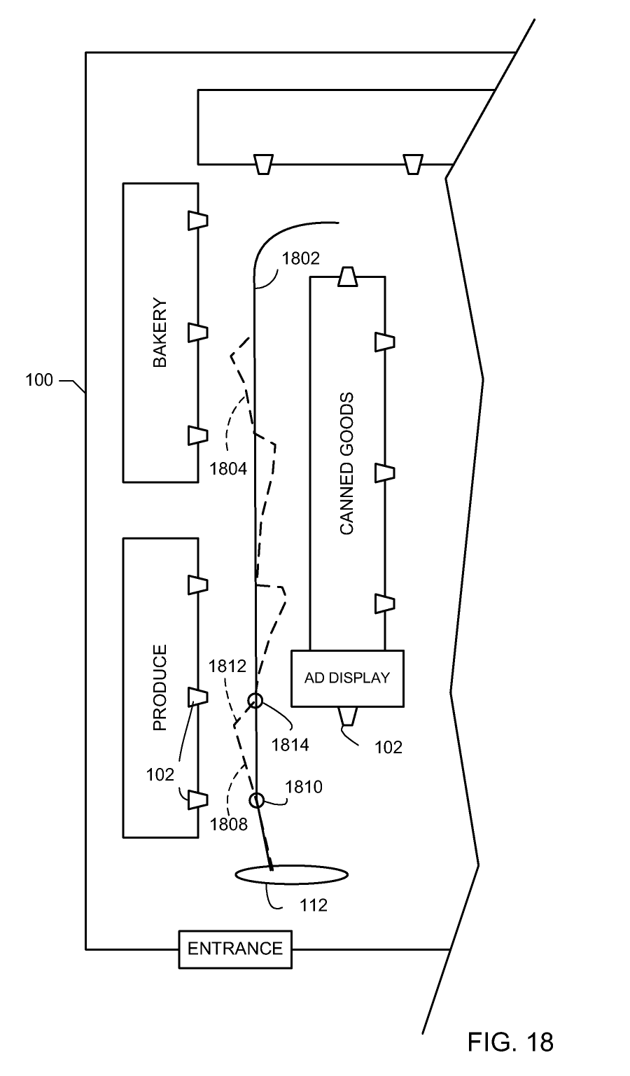

Referring briefly to FIG. 18, a portion of the monitored environment 100 is shown with an actual path of travel 1802 and a calculated path of travel 1804. The actual path of travel 1802 is indicative of the actual movements of the person 106 through the monitored environment 100. The calculated path of travel 1804 is indicative of the path calculated by the tag 104 and/or the server 114 based on information collected by the tag 104. In the illustrated example, a segment 1808 is calculated using dead-reckoning techniques to determine the relative location of the shopper 106 relative to an absolute location 1810. In the illustrated example, the absolute location 1810 can be determined based on chirps received from the three nearest stationary location devices 102. Using the dead reckoning technique, the calculated path 1804 veers away from the actual path 1802 of the person 106 as shown by the segment 1808. When the person 106 reaches a location at which the tag 104 can detect chirps from one or more of the stationary location devices 102, the tag 104 and/or the server 114 can use the detected chirps to correct the calculated path of travel 1804 as shown by segment 1812. The segment 1812 converges the calculated path of travel 1804 with actual location information 1814. In this manner, actual location information (e.g., the actual location information 1814) can be used to periodically or aperiodically align the calculated path of travel 1804 with the actual path of travel 1802.

Returning to FIG. 1, in some example implementations, the tag 104 can record and store the received ultrasonic chirps (e.g., in a digital format) and corresponding timestamps indicative of times of receipt and communicate the recorded ultrasonic chirps and timestamps to the server 114 and/or the server 122 of the central collection facility 116 for subsequent analysis. For example, the tag 104 can be provided with a digital audio recording device (e.g., the digital audio recorder 218 of FIG. 2) configured to store the received ultrasonic chirps. In some example implementations, the tag 104 can be configured to convert the received chirps to the human audible range prior to recording the chirps with the digital audio recording device. The tag 104 can then communicate (e.g., via wired or wireless communications) the recorded ultrasonic chirps and relative location information generated using a dead reckoning process or an improved dead reckoning process as described above to the server 114, which may be located in or proximate to the monitored environment 100.

In addition to or as an alternative to configuring the tag 104 to periodically (or aperiodically) determine absolute location information based on received ultrasonic chirps, the server 114 can be configured to analyze the recorded chirps to determine and/or refine the location information generated by the tag 104 or for any other analysis purpose. That is, to conserve battery power of the tags 104 and 108, the tags 104 and 108 may be configured not to analyze the received ultrasonic chirps, but to instead record them (or at least some of them) and subsequently communicate the recorded chirps to the server 114 or the server 122 of the central facility 116 along with relative location information generated using dead reckoning processes. The server 114 or the server 122 at the central facility 116 can post process the recorded chirps to generate absolute location information and to substantially reduce and/or eliminate any error in the relative location information. The server 114 can be used to perform more complex processing of the ultrasonic chirps (e.g., process or analyze signal characteristics of the chirps and unique ID's embedded therein) and the location information because the server 114 has more processing power than the tag 104 and is not subject to the limited battery power constraints and/or processing constraints of the tag 104. For example, the server 114 can measure the signal characteristics of the recorded chirps and/or extract the unique ID's from the recorded chirps, and can then use the signal characteristics and/or the ID's in connection with, for example, triangulation techniques to determine absolute location information to increase the accuracy of the relative location information generated using the dead reckoning process. The server 114 can also perform smoothing processes and/or other heuristics-based processes that are relatively more powerful or complex than processes that the tag 104 can perform.

In some example implementations, the server 114 (or the server 122 at the central facility 116) uses the data received from the tags 104 and 108 to determine detected unique ID's and corresponding times by selecting the strongest recorded chirp for each timestamp generated by the tags 104 and 108. In some example implementations, the tags 104 can select the ID's corresponding to the strongest signals and store only those selected ID's and corresponding timestamps for subsequent communication to the server 114. However, communicating all of the recorded chirps (or all of the detected ID's and their strengths) to the server 114 (or the server 122 at the central facility 116) enables increasing the accuracy of location information using smoothing and/or other heuristics-based processes to process substantially all of the information. For example, while the tags 104 and 108 have sufficient processing power to implement a selection process that selects the strongest received signal from a plurality of received signals at any one time, the server 114 may be configured to use substantially more complex processes that, for example, select a second strongest signal if it is only slightly weaker than a strongest signal. Additionally, the server 114 may be configured to determine whether a strongest signal corresponds to a location in the environment 100 that is too far away from an immediately previous location based on an amount of time elapsed since determining the previous location. That is, the server 114 can determine the validity of two consecutive location information records by determining whether it was possible for a person to move a distance between the two consecutive locations during a time elapsed between collection of the two location information records.

The server 114 may also be configured to compare chirps that were received temporally adjacent to one another to determine whether strongest signals corresponding to consecutive chirp acquisition periods include matching unique ID's, and if so, determine that a person was standing in the same place for an extended duration. In some example implementations, the tag 104 may acquire ultrasonic chirps from two of the stationary location devices 102 when it is equidistant from each emitter. To determine relatively accurate location information in these types of instances, the server 114 may be configured to determine the locations of the stationary location devices corresponding to the detected ultrasonic chirps and determine the location of the tag 104 by finding a substantially midway location (e.g., an average) between the locations of the stationary location devices.

In the illustrated example, the stationary location devices 102 are installed in a rectangular grid pattern through the monitored environment 100. The stationary location devices 102 are installed at various distances (e.g., distances of (N) feet) from one another up to a maximum distance of (M) feet from one another. The maximum distance (M) is selected based on the ultrasonic strength that can be emitted by each of the stationary location devices 102 and the sensitivity of the ultrasonic receivers (e.g., microphones) provided in the tags 104 and 108. For example, an approximate value of (M) is forty feet and can change depending on the amount of acceptable error or inaccuracy in calculated location information. The quantity of stationary location devices 102 installed in a particular retail aisle may be based on the number of location zones desired for that aisle. For example, some of the aisles of the monitored environment 100 are provided with three zones. Having more zones enables producing relatively more accurate location information. In some example implementations, some of the stationary location devices 102 may be installed next to, adjacent to, near, or proximate to products or product categories of interest to a particular retail store or to product manufacturers, thus ensuring relatively more accurate location information associated with those products of interest to determine with relatively high accuracy when the person 106 was next to those products or product categories of interest.

In some example implementations, the unique ID's of the stationary location devices 102 may be used to identify products, advertisements, and/or other product-related information (e.g., media sources, media presentations, etc.) located proximate to the stationary location devices 102. For example, each unique ID can be associated with a product ID or advertisement ID in a data structure stored in a product and advertisement database 118 which is communicatively coupled to the server 114 or a product and advertisement database 120 at the central facility 116. For example, the stationary location devices 102 located in aisles adjacent to product shelves or displays can be associated with product ID's and the stationary location devices 102a associated with advertisement displays (but no products) can be associated with advertisement ID's. In this manner, the server 114 or the server 122 at the central facility 116 can determine the products and/or advertisements that people were exposed to when walking through the monitored environment 100. For example, after extracting the unique ID from an ultrasonic chirp, the server 114 can compare the unique ID with unique ID's stored in the product and advertisement database 118 to retrieve a corresponding product ID or advertisement ID stored in association with the received unique ID. Additionally or alternatively, the product and advertisement databases 118 and 120 can have data structures that store product and/or advertisement ID's in association with location information (e.g., location coordinates or location zone identifiers) corresponding to the locations in the environment 100 of one or more products and/or advertisements. In this manner, location information generated based on data collected by the tags 104 and 108 can be used to retrieve corresponding product and/or advertisement ID's from the product and advertisement databases 118 and 120. In some example implementations, the data structures that associate product and/or advertisement ID's to location information may associate the product and/or advertisement ID's to location ranges or zones. In this manner, if location information indicates that the tag 104 was located within a particular range of locations (e.g., a zone), a corresponding product ID and/or advertisement ID can be retrieved based on that range. Alternatively, the data structure may associate a specific location with each product ID and advertisement ID, and the server 114 can select a particular product ID or advertisement ID if it determines that the location associated with that product ID or advertisement ID is close enough to a location of the tag based on a threshold value.

In some example implementations, the tags 104 and 108 can be configured to collect and store information other than location related information. In particular, the tags 104 and 108 could be configured to detect and store crowd noise levels and/or ambient temperature. The crowd noise levels can be used to determine the quantity of people in an area surrounding the location of a tag. To detect crowd noise, the tags 104 and 108 could be provided with a secondary audio sensor (e.g., a microphone) or the tags 104 can use one audio sensor to detect both the ultrasonic chirps from the stationary location devices 102 and the crowd noise. The ambient temperature measurements could be used to analyze the effects of temperature on shopping behavior. In addition, a retail store may use the temperature information as thermostat information to adjust store temperature. For example, each of the tags 104 and 108 can be provided with a temperature sensor and can be configured to store the temperature information in a respective memory for subsequent communication to the server 114. Additionally or alternatively, the tags 104 and 108 can be configured to communicate the temperature information in real-time to the server 114 so that an HVAC system of the monitored environment 100 can use the temperature measurements as thermostat information to adjust the temperature of the monitored environment 100 based on, for example, correlations between shopper behaviors and ambient temperatures. For example, one or more thermostats of the HVAC system can be controlled to adjust temperature levels through the monitored environment 100 and/or in one or more specific location(s) of the environment 100 to temperatures known to improve customer satisfaction and/or sales. Different temperatures may be associated with different product types. For example, it might be beneficial to have a lower temperature in an area frequented by men (e.g., sporting goods) than an area frequented by women (e.g., women's apparel).

The stationary location devices 102 can be programmed with their unique ID's using any suitable technique. For example, the stationary location devices 102 can be programmed with unique ID's at the time of their manufacture. However, in a preferable example implementation, the stationary location devices 102 are programmed with their unique ID's when they arrive at the monitored environment 100. If the stationary location devices 102 are programmed when they arrive at the monitored environment 100, the stationary location devices 102 can be programmed using a wireless communication interface such as an infrared (IR) interface, a radio frequency (RF) interface, an ultrasonic interface, etc. A programmer device having a corresponding wireless interface can be implemented using a computer (e.g., a laptop, a desktop, a tablet, etc.) or a handheld computing device. In some example implementations, the stationary location devices 102 can be networked wirelessly to one another and/or to the server 114 using, for example, a ZigBee® network (comprising a plurality of ZigBee® transmitters, receivers, and/or transceivers) configured to operate based substantially on the standard IEEE 802.15.4. In this manner, the server 114 can program the stationary location devices 102 via the ZigBee® network.

In some example implementations, the stationary location devices 102 can be provided with dip switches and can each be set to a unique ID using the dip switches. In this manner, any signal spillover to adjacent stationary location devices associated with wireless communications can be substantially eliminated. However, care should be taken to prevent tampering with the dip switches. For example, the dip switches can be secured using a locked cover plate.

In yet other example implementations, the stationary location devices 102 can be programmed with their unique ID's using wired communication interfaces (e.g., universal serial bus (USB) interfaces, phono jack interfaces, network interfaces, etc.). A cable interface programming process can be configured to program the stationary location devices 102 in an automatic fashion. For example, each time a stationary location device 102 is connected to a programming computer, a central computer, or a handheld device, the computer or handheld device can set the unique ID of that stationary location device 102 to a next higher value relative to a previously programmed stationary location device. Of course, any other programming scheme can be used instead of, or in addition to, the above-described techniques.

To motivate the person 106 to turn-in or return the tag 104 carried by the person 106 before leaving the monitored environment 100, one or more tag check-in systems 132 is provided at the checkout counters. The tag check-in systems 132 are configured to scan or otherwise receive the identification number of each of the tags 104 and/or 108 returned at the checkout counter by patrons that agreed to participate in the market research program. The tag check-in systems 132 are configured to implement an incentive program to reward patrons that turn in the tags 104 and/or 108. The incentive program may be configured to reward the patrons with coupons or discounts for merchandise or products for current or future transactions. The incentive process may additionally or alternatively be configured to reward the patrons with discounts, reward points, money, or other valuable offerings unrelated to the services or products available at the example indoor environment 100. The incentive program provides motivation for patrons that would otherwise be inclined to leaving the tags 104 and/or 108 at other locations in the example indoor environment 100 or that might forget to turn in the tags 104 and 108 when leaving the indoor environment 100. In some cases, patrons that leave the indoor environment 100 without purchasing anything may feel that any data collected by their tag 104 or 108 is useless. However, market research companies may be interested in the data collected by the tags 104 and/or 108 regardless of whether their respective carriers purchased anything. Thus, in some example implementations it may be desirable to motivate all tag bearers to turn in their tags.

To retrieve data collected by the tags 104 and/or 108, one or more docking stations 134 are provided at the checkout counters. The docking stations 134 are configured to be communicatively coupled to the tags 104 and/or 108 via wireless or wired communication mediums to retrieve the information stored in the tags 104. In some example implementations, cashiers at the checkout counters can place the tags 104 and/or 108 in contact with or in proximity to the docking stations 134 to enable the tags 104 and/or 108 to communicate the information (e.g., location information) to the server 114 via the docking stations 134. An example docking station 1400 that may be used to implement the docking stations 134 is described below in connection with FIGS. 14A, 14B, 15, 16, and 17.

FIG. 2 is a detailed block diagram of the example tag 104 (and/or the tags 108) of FIG. 1. As described above, the tag 104 may be used to monitor people's (e.g., the person 106 of FIG. 1) locations and exposures to media sources, media presentations, products, advertisements, etc. The example tag 104 may be implemented using any desired combination of hardware, firmware, and/or software. For example, one or more integrated circuits, discrete semiconductor components, and/or passive electronic components may be used. Additionally or alternatively, some or all of the blocks of the example tag 104, or parts thereof, may be implemented using instructions, code, and/or other software and/or firmware, etc. stored on a machine accessible medium that, are executed by, for example, a processor system (e.g., the example processor system 1910 of FIG. 19). In general, the tag 104 includes electronic components configured to detect and collect location-related information and motion information and to communicate the information to the server 114 and/or the server 122 of the central facility 116 (FIG. 1) for subsequent analyses. As shown in FIG. 2, the tag 104 includes a processor 202, a memory 204, a timing device 205, a communication interface 206, one or more audio sensor(s) 208, an RF sensor 210, one or more motion sensor(s) 212, a compass 214, a SPSR 216, a digital audio recorder 218, a thermometer 220, a plurality of output devices 222, an input interface 224, and a visual interface 226, all of which are communicatively coupled as shown.

The processor 202 may be any processor suitable for controlling the tag 104 and managing or processing monitoring data related to location-related information, motion information, temperature information, etc. For example, the processor 202 may be implemented using a general purpose processor, a digital signal processor, or any combination thereof. The processor 202 may be configured to perform and control various operations and features of the tag 104 such as, for example, setting the tag 104 in different operating modes, controlling a sampling frequency for detecting and/or collecting information, managing communication operations with other processor systems (e.g., the server 114, the server 122 of the central facility 116, the stationary location devices 102, the docking stations 134, etc. of FIG. 1), selecting location information systems (e.g., a dead-reckoning system, the stationary location devices 102, or a GPS unit), etc.

The memory 204 may be used to store collected information, program instructions (e.g., software, firmware, etc.), program data (e.g., location information, motion information, etc.), and/or any other data or information used to operate the tag 104. For example, after acquiring location information, motion information, and/or media monitoring information, the processor 202 may time stamp the acquired information and store the time stamped information in the memory 204. The memory 204 may be implemented using any suitable volatile and/or non-volatile memory including a random access memory (RAM), a read-only memory (ROM), a flash memory device, a hard drive, an optical storage medium, etc. In addition, the memory 204 may be any removable or non-removable storage medium.

The timing device 205 may be implemented using a clock (e.g., a real-time clock), a timer, a counter, or any combination thereof. The timing device 205 may be used to generate timestamps or used to implement any timing operations. Although the timing device 205 is shown as separate from the processor 202, in some implementations the timing device 205 may be integrated with the processor 202.

The communication interface 206 may be used to communicate information between the tag 104 and other processor systems including, for example, the server 114, the server 122 of the central facility 116, the docking stations 134, etc. of FIG. 1. The communication interface 206 may be implemented using any type of suitable wired or wireless transmitter, receiver, or transceiver including a Bluetooth® transceiver, an 802.11 transceiver, a cellular communications transceiver, an optical communications transceiver, etc.

The example tag 104 is configured to use the audio sensor 208 and/or the RF sensor 210 to observe the environment in which the person 106 is located or moving (e.g., walking, shopping, etc.) and monitor for signals associated with the locations of the person 106. When a signal is detected from, for example, one of the stationary location devices 102 of FIG. 1, the example tag 104 logs or stores a representation and/or characteristic(s) of the signal in the memory 204 along with a timestamp indicative of the time at which the signal was detected.

The audio sensor 208 may be, for example, a condenser microphone, a piezoelectric microphone or any other suitable transducer capable of converting audio information (e.g., human-audible audio or audio not audible to humans) into electrical information. The RF sensor 210 may be, for example, a Bluetooth® transceiver, an 802.11 transceiver, an ultrawideband RF receiver, and/or any other RF receiver and/or transceiver. In addition, the RF sensor 210 may be implemented using only an RF receiver or only an RF transmitter. While the example tag 104 of FIGS. 1 and 2 includes the audio sensor 208 and the RF sensor 210, the example tag 104 need not include both of the sensors 208 and 210. For example, the audio sensor 208 is sufficient to identify ultrasonic chirps or other audio chirps from the stationary location devices 102 of FIG. 1.

Examples of known location-based technologies that may be implemented in cooperation with the RF sensor 210 include the Ekahau Positioning Engine by Ekahau, Inc. of Saratoga, Calif., United States of America, an ultrawideband positioning system by Ubisense, Ltd. of Cambridge, United Kingdom or any of the ultrawideband positioning systems provided by Multispectral Solutions, Inc. of Germantown, Md., United States of America. Ultrawideband positioning systems, depending on the design, offer advantages including long battery life due to low power consumption and high precision. Further, such systems tend to use less of the available signal spectrum.

The Ekahau Positioning Engine may be configured to work with a plurality of standard wireless communication protocol base stations (e.g., the 802.11 protocol, the Bluetooth® protocol, etc.) to broadcast location-related information. By implementing the RF sensor 210 using a suitable wireless communication protocol device and communicatively coupling the stationary location devices 102 to the RF sensor 210 using the same communication protocol, the Ekahau Positioning Engine may be used to generate location information. In particular, location-related information may be transmitted from the stationary location devices 102, received by the RF sensor 210, and used to generate location information using Ekahau Positioning software offered by Ekahau, Inc.

The Ubisense ultrawideband system may be used by communicatively coupling an ultrawideband transmitter to each of the stationary location devices 102 and implementing the RF sensor 210 using an ultrawideband receiver. In this manner, the RF sensor 210 can receive ultrawideband location-related information that is broadcast from the stationary location devices 102 so that the tag 104 can generate location information based on the received ultrawideband signals.

The satellite positioning system receiver (SPSR) 216 may be implemented using, for example, a global position system (GPS) receiver and may be configured to generate location information based on encoded GPS signals received from GPS satellites. In general, the SPS receiver 216 may be used by the tag 104 to collect location information in outdoor environments.

To determine relative location information in connection with, for example, a dead-reckoning process, the tag 104 is provided with navigational data sensors or navigational data generators including the motion sensor(s) 212 and the compass 214. The navigational data sensors 212 and 214 generate navigational sensing information without requiring external signals (e.g., location signals, audio signals, radio frequency signals, global positioning system (GPS) signals, etc.). Instead, the navigational data sensors 212 and 214 have internal components (e.g. magnetic field sensors, accelerometers, gyroscopic components, etc.) that sense movement, motion, and/or direction to generate the navigational sensing information. In the illustrated example, the motion sensor(s) 212 and the compass 214 may be used to generate motion and direction of travel information to generate the relative location information as described above in connection with FIG. 1 to indicate the location of the tag 104. The motion sensor(s) 212 may be implemented using an accelerometer, a gyroscope, a trembler, etc. to generate acceleration information, movement information, etc. The compass 214 may be implemented using a magnetic field sensor, an electronic compass IC, and/or any other suitable electronic circuit. In general, the compass 214 may be used to generate direction information, which may be useful in determining the direction in which a person (e.g., the person 106) is facing and/or moving. The direction information may be used to determine if a person is facing a product, an advertisement, product information, or any other media.

The digital audio record 218 may be used to record digital audio representations of signals or chirps received from, for example, the stationary location devices 102 of FIG. 1. The processor 202 can store the digital audio representations in the memory 204 for subsequent communication to a server (e.g., the server 114 of FIG. 1 and/or the server 122 of the central facility 116 of FIG. 1). In some example implementations, the digital audio recorder 218 can be configured to convert the received chirps to the human audible range prior to encoding and/or recording the chirps. The digital audio recorder 218 can include an encoder or converter implemented using any suitable digital audio encoding and/or compression standard including, for example, the MPEG-1, layer 3 (MP3) standard, the WAV standard, the Advanced Audio Coding (AAC) standard, etc.

The thermometer 220 can be used to measure the ambient temperature(s) of area(s) traversed by the tag 104, and the processor 202 can store the temperature measurement(s) in the memory 204. In some example implementations, a retail establishment may use the temperature information as thermostat information to adjust store temperature(s).

The plurality of output devices 222 may be used to capture the attention of audience members, alert audience members (e.g., the audience member 106 of FIG. 1), provide information to audience members, and/or request input from audience members. The plurality of output devices 222 includes a speaker 222a, a vibrator 222b, and a visual alert 222c.

The speaker 222a may also be used to communicate chirps to the stationary location devices 102 in example implementations in which the stationary location devices 102 are implemented as receivers instead of emitters. In particular, the speaker 222a may be used to inform the stationary location devices 102 that the tag 104 is within proximity of the stationary location devices 102. The speaker 222a may be implemented using any type of acoustic emitter. For example, the speaker 222a may be implemented using a speaker capable of emitting audio in the human audible range or a range not audible by humans. Alternatively or additionally, the speaker 222a may be implemented using a speaker or transducer capable of emitting ultrasound audio for use with ultrasound location detection systems. Although one speaker is shown in FIG. 2, the tag 104 may include any number of speakers, each of which may be configured to suit a particular function (e.g., a speaker to emit acoustic frequencies in the human audible range and a speaker or transducer to emit ultrasound frequencies).

The tag 104 may also include the input interface 224, which may be used by a person (e.g., the person 106) to input information to the tag 104. For example, the input interface 224 may include one or more buttons or a touchscreen that may be used to enter information, set operational modes, turn the tag 104 on and off, etc. In addition, the input interface 224 may be used to enter tag settings information, audience member identification information, demographic information, etc.

The tag 104 may further include the visual interface 236, which may be used in combination with the input interface 234 to enter and retrieve information from the tag 104. For example, the visual interface 236 may be implemented using a liquid crystal display (LCD) that, for example, displays detailed status information, location information, configuration information, calibration information, etc. In some cases, the visual interface 226 may include light-emitting diodes (LEDs) that convey information including, for example, status information, operational mode information, etc.

FIG. 3 is an example location monitoring system 300 that may be used to implement the methods and apparatus described herein. The monitoring system 300 may be configured to work with the example tags 104 and 108 (FIGS. 1 and 2) to generate location information associated with the location of a person (e.g., the person 106 of FIG. 1) within a monitored environment (e.g., the monitored environment 100 of FIG. 1). The monitoring system 300 or another processing system (e.g., the server 114 or the server 122 of the central facility 116 of FIG. 1) may then use the location information to determine the path(s) walked by the person 106 and products, advertisements, and/or other media or information to which the person 106 was exposed along those path(s).

As shown in FIG. 3, the monitoring system 300 includes two base units 302a and 302b communicatively coupled to a data interface unit 304 via a network hub 306. The base units 302a-b are communicatively coupled to a plurality of satellite units 308, which may be used to implement the stationary location devices 102 of FIG. 1. The monitoring system 300 may be implemented using ultrasound technologies, any other audio emitting technology, or any suitable RF technology. The base sensor units 302a-b and the satellites sensor units 308 may include audio emitters or RF transmitters to emit or transmit chirps detectable by the tags 104 and 108 of FIG. 1. Alternatively, if the tags 104 and 108 are provided with signal emitters to emit chirps and the stationary location devices 102 are configured to receive chirps from the tags 104 and 108, the satellite units 308 can be provided with microphones or transducers that enable the units 302a-b and 308 to detect tag ID signals emitted by the tags 104 and 108. Each of the base units 302a-b may have eight data acquisition or transmission channels numbered zero through seven. Each of the base sensor units 302a-b may be coupled to data acquisition channel zero. Each of the satellite units 308 may be coupled to a respective one of the data acquisition channels one through seven of the base units 302a-b.

The base units 302a-b may be communicatively coupled to the data interface unit 304 using any suitable networking standard (e.g., Ethernet, Token Ring, etc.). In some example implementations, the data interface unit 304 may be implemented using the server 114 of FIG. 1. Although the base units 302a-b are shown as being coupled via wires to the data interface unit 304, the base units 302a-b may alternatively be coupled to the data interface unit 304 and/or the network hub 306 via wireless interfaces. In alternative example implementations, the base units 302a-b may be communicatively coupled to the server 122 of the central facility 116 using a wired or wireless communication protocol. Each of the base units 302a-b may be assigned a unique internet protocol (IP) address that enables each of the base units 302a-b to communicate with the data interface unit 304. The data interface unit 304 may store the information received from the base units 302a-b in a database and/or communicate the information to, for example, the central facility 116 (FIG. 1).

The base units 302a-b may be powered by an alternating current (AC) source (e.g., a wall outlet) or a direct current (DC) source (e.g., an AC-DC converter plugged into a wall outlet). The satellite units 308 may be powered by the base units 302a-b. Specifically, a cable used to couple a satellite unit 308 to one of the base units 302a-b may include a data communication link that is coupled to one of the data acquisition channels zero through seven and a power link that is coupled to a power supply of the one of the base units 302a-b.

The units 302a-b and 308 may be placed throughout the monitored environment 100 as described above in connection with the stationary location devices 102 and each may be assigned a location ID or a unique ID corresponding to a location and/or a zone in which it is located.

Although the example system 300 is described as being able to be used to implement the stationary location devices 102 of FIG. 1, the stationary location devices 102 may alternatively be implemented using other devices. For example, each of the stationary location devices 102 may be implemented using a stand alone device having a signal emitter or transmitter, dip switches to set a unique ID, and/or a memory to store a unique ID.

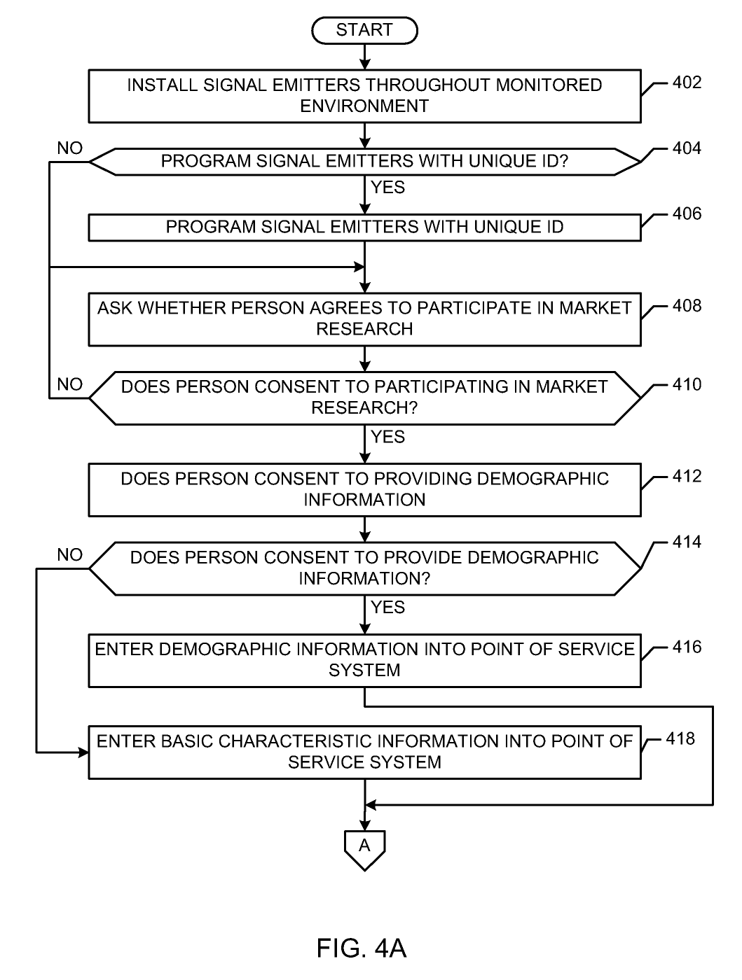

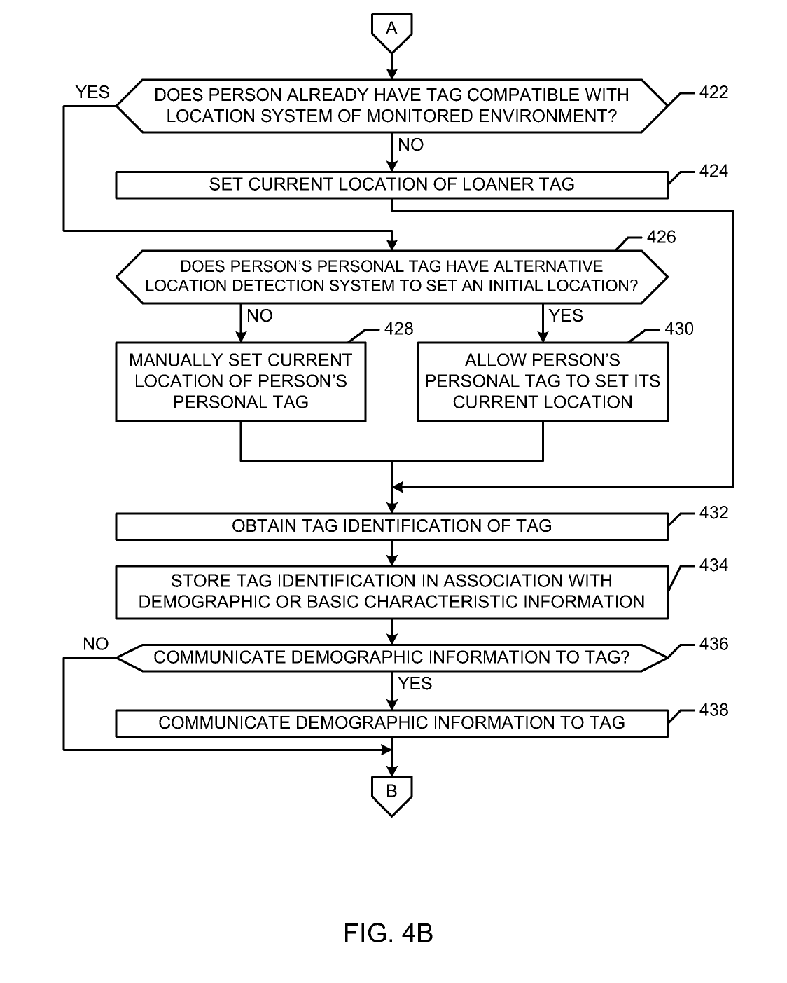

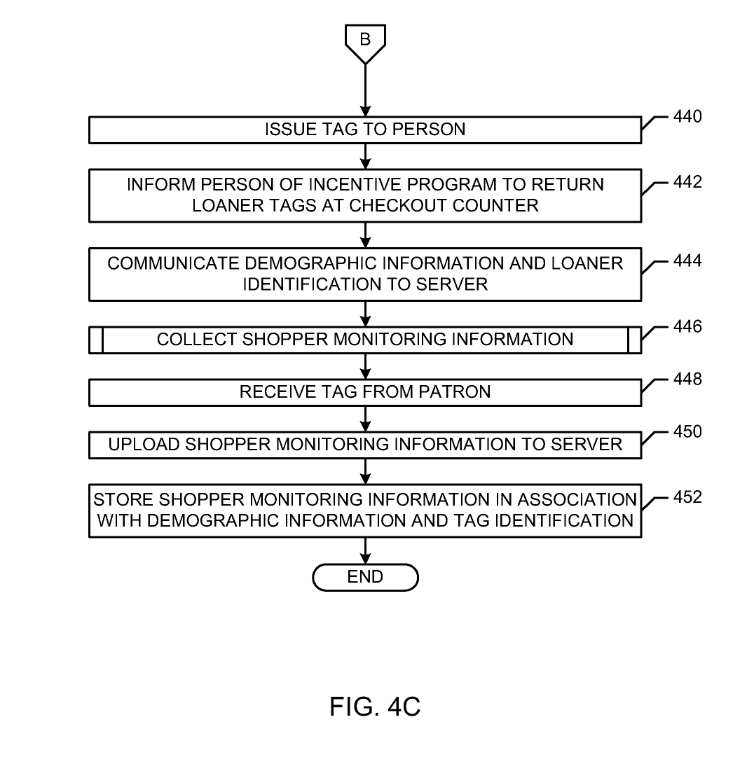

FIGS. 4A-4C depict a flow diagram of an example method that may be used to configure the example location detection system of FIG. 1 to collect shopper monitoring information. Initially, a technician installs the stationary location devices 102 throughout the monitored environment 100 (block 402) as described above in connection with FIG. 1. The technician then decides whether to program the stationary location devices 102 with their respective unique ID's (block 404). For example, if the stationary location devices 102 are not preprogrammed, the technician will have to program the stationary location devices 102. If the technician determines that the stationary location devices 102 need to be programmed (block 404), the technician programs the stationary location devices 102 with their respective unique ID's (block 406) using any suitable technique including, for example, any of the techniques described above in connection with FIG. 1.

If the technician decides not to program the stationary location devices 102 because they have already been programmed (block 404), or after programming the stationary location devices 102 (block 406), a market research person who stands by an entrance of the monitored environment 100 asks a person 106 entering the monitored location if the person 106 would like to participate in a market research program (block 408). If the person 106 does not consent to participating in the market research program (block 410), the market research person continues to ask other patrons of the monitored environment 100 whether they would like to participate in the market research program. However, if the person 106 consents to participating in the market research program (block 410), the market research person determines whether the person 106 consents to provide demographic/personal information (block 412). If the person 106 consents to providing their demographic/personal information (block 414), the market research person enters the demographic/personal information received from the person 106 in the point of service system 111 (block 416). For example, the market research person may ask the person 106 survey questions presented via the point of service system 111 and enter the responses of the person 106 into the point of service system 111. In the illustrated example, if the person 106 does not consent to providing demographic/personal information (block 414), the market research person can enter basic characteristic information into the point of service system 111 (block 418). Such basic characteristic information should be of a nature that can lawfully (with respect to local law or other applicable law) be obtained and stored without consent. For example, the basic characteristic information may be indicative of whether the person is shopping in a party of two or more people or the gender of the person. In other example implementations, the market research person may be instructed not to obtain any demographic/personal information and/or any basic characteristic information, particularly if the tag bearer refuses to provide the same.

After entering the demographic/personal information at block 416 or after entering the basic characteristic information at block 418, the market research person determines whether the person 106 already has a tag that is compatible with the location detection system of the monitored environment 100 (block 422) (FIG. 4B). For example, the person 106 may be a participant in market research studies outside of the monitored environment 100 that require the person 106 to carry a tag or a personal portable meter (PPM). In the illustrated example, the tag or PPM is compatible with the location detection system of the monitored environment 100 (1) if the tag or PPM has a dead reckoning system and software, (2) if the tag or PPM can detect and store the ultrasonic chirps from the stationary location devices 102, and (3) if the tag or PPM can upload the stored ultrasonic chirp and dead reckoning positioning information to the server 114 (FIG. 1).

If the person 106 does not have a tag or PPM compatible with the location detection system of the monitored environment 100 (block 422), the market research person sets the current location of a loaner tag (e.g., the tag 104 or one of the tags 108 associated with a shopping cart) (block 424) based on the known location 112 (FIG. 1). The known location can be entered using global latitude and longitude coordinates or other coordinates (e.g., X, Y) associated with, for example, a grid pattern corresponding to the monitored environment 100.

If the person 106 has a personal tag or PPM compatible with the location detection system of the monitored environment 100 (block 422), the market research person decides whether the person's personal tag has an alternative location detection system to set an initial location (block 426). For example, a personal tag may be equipped with a GPS receiver, in which case the last GPS-based location determined by the personal tag when it was located outside the monitored environment 100 can be used as the initial location to determine subsequent location information using dead reckoning techniques.

If the market research person determines that the personal tag does not have an alternative location detection system (block 426), the market research person manually sets a current known location in the personal tag (block 428) based on the known location 112. Otherwise, the personal tag of the person 106 sets its current location (block 430). For purposes of discussion, subsequent operations will be described in connection with the person 106 carrying the tag 104. After the market research person sets the current known location of the personal tag 104 (block 428) or after the personal tag 104 sets its initial location using its alternative location detection system (block 430), the market research person obtains a tag identification of the tag 104 (block 432). For example, the market research person can scan a barcode on the tag 104 using the point of service system 111 or may use any other suitable technique to obtain the identification of the tag 104. The point of service system 111 then stores the tag identification in association with any demographic/personal information or basic characteristic information (block 434) obtained at blocks 416 or 418 above.

The point of service system 111 then determines whether to communicate the demographic/personal information (or basic characteristic information) to the tag 104 (block 436). If the point of service system 111 determines that it should communicate the demographic/personal information to the tag 104 (block 436), the point of service system 111 communicates the demographic/personal information (or basic characteristic information) to the tag 104 (block 438). After the point of service system 111 communicates the demographic/personal information to the tag 104 (block 438) or if the point of service system 111 determines that it should not communicate the demographic/personal information to the tag 104 (block 436), the market research person then issues the tag 104 to the person 106 (block 440) (FIG. 4C). In addition, the market research person informs the person 106 of an incentive program that rewards patrons for returning loaner tags at a checkout counter (block 442). For example, the rewards may include instant savings, coupons, reward points, etc. The point of service system 111 then communicates the demographic/personal information (or basic characteristic information) and the tag identification to the server 114 (block 444). Of course, the patron 106 may be informed of the rewards system at any other time (e.g., when asked if they are willing to participate).

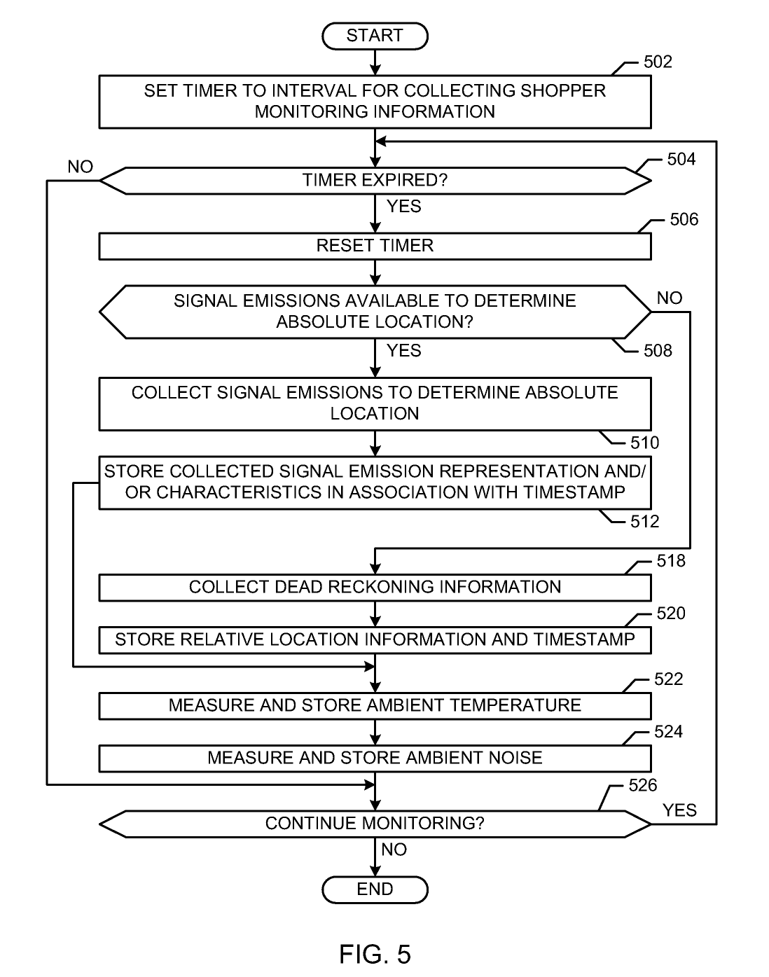

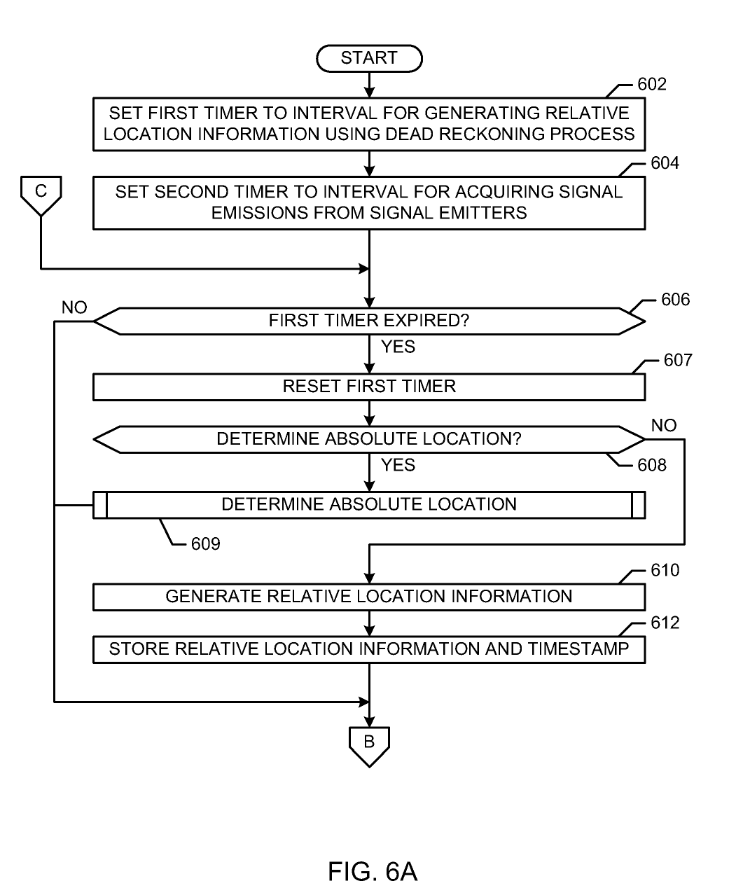

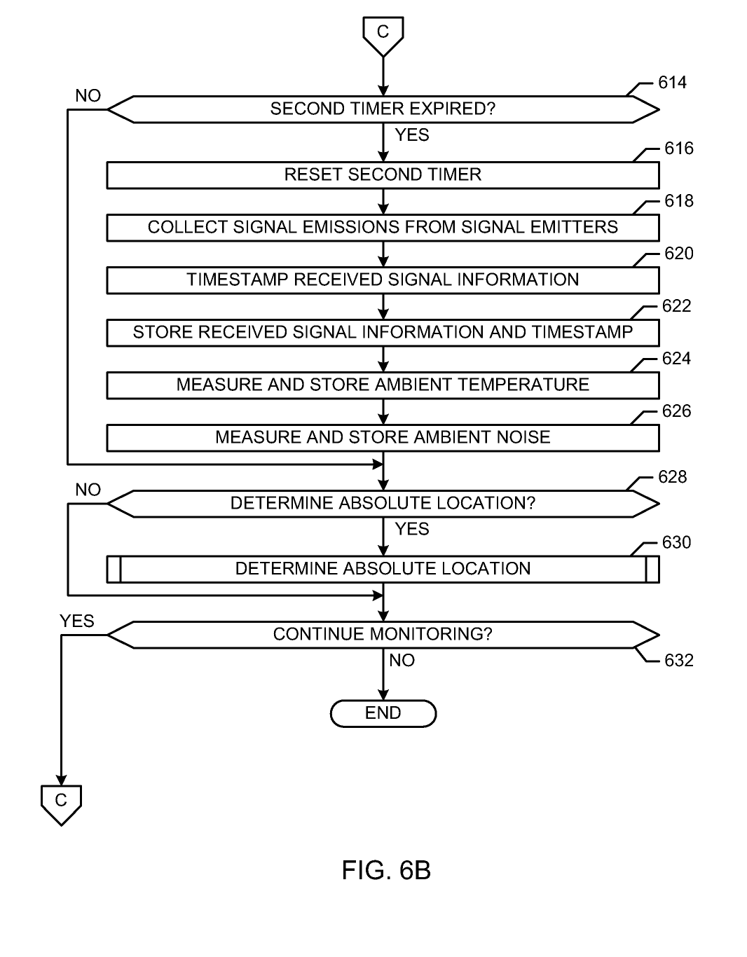

The tag 106 then collects shopper monitoring information (block 446) as the person 106 moves through the monitored environment 100. Example processes that may be used to implement block 446 are described below in connection with FIGS. 5, 6A, and 6B. When the person 106 has finished shopping, a cashier at a checkout station receives the tag 104 from the person 106 (block 448). The collected shopper monitoring information is then uploaded to the server 114 (block 450) using any suitable wired or wireless communication techniques. The server 114 then stores the shopper monitoring information in association with the demographic/personal information of the person 106 and the identification of the tag 104 (block 452). The example process of FIGS. 4A-4C then ends.

FIG. 5 depicts an example method that may be used to implement the location detection system of FIG. 1 to collect shopper monitoring information including location information indicative of the locations traversed by the person 106 as the person 106 walks through the monitored environment 100. The example method of FIG. 5 may be used to implement block 446 of FIG. 4C. Initially, the tag 104 sets a timer (e.g., using a timer substantially similar or identical to the timing device 205 of FIG. 2) to an interval indicative of when the tag 104 should collect shopper monitoring information (block 502).

The tag 104 then determines whether the timer has expired (block 504). When the timer expires (block 504), the tag 104 resets the timer (block 506) and determines whether signal emissions from the stationary location devices 102 are available to determine absolute location information (block 508). In the illustrated example, the tag 104 is configured to collect signal emissions to determine absolute location information whenever possible and the dead reckoning techniques to determine relative location information are used whenever absolute location information cannot be determined. That is, under some circumstances the tag 104 may only have the option of using the more error-prone dead reckoning methods because the tag 104 is located in an area where it is not receiving chirps from any of the stationary location devices 102. If the tag 104 is in a location in the environment 100 in which it can receive chirps from enough of the stationary location devices 102 to determine absolute location information (block 508), the tag 104 collects signal emissions from the stationary location devices 102 for use in subsequently determining absolute location information (block 510). In some example implementations, the tag 104 may be configured to collect and store the three strongest ultrasonic chirps (or some other quantity of strongest chirps) and discard the rest for a particular acquisition instance. In this manner, three signals can be used for triangulation during subsequent location determination processes performed by the server 114 and/or the server 122 at the central facility 116. In other example implementations, the tag 104 may be configured to collect all of the ultrasonic chirps detected, and the server 114 may be configured to select which of the ultrasonic chirps to use to determine the locations of the tag 104.

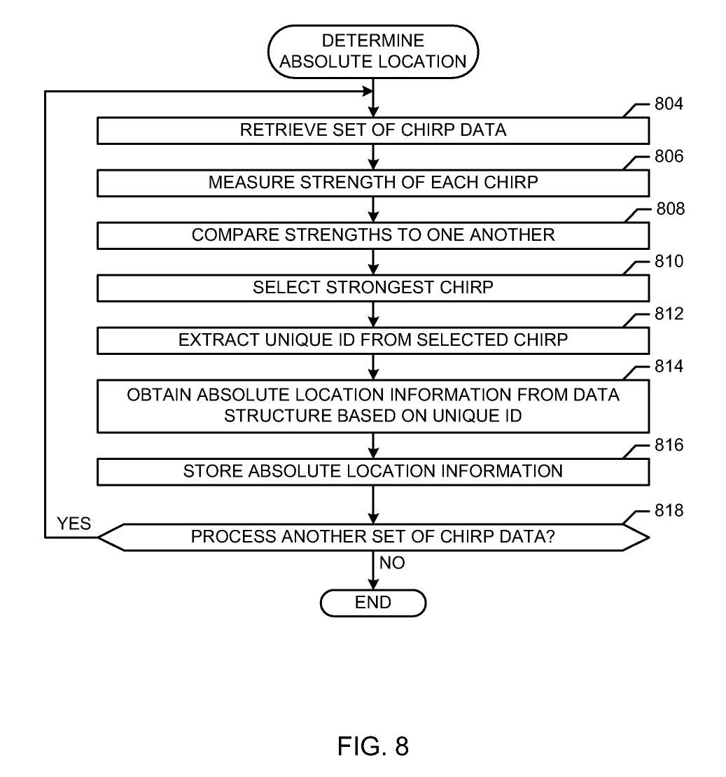

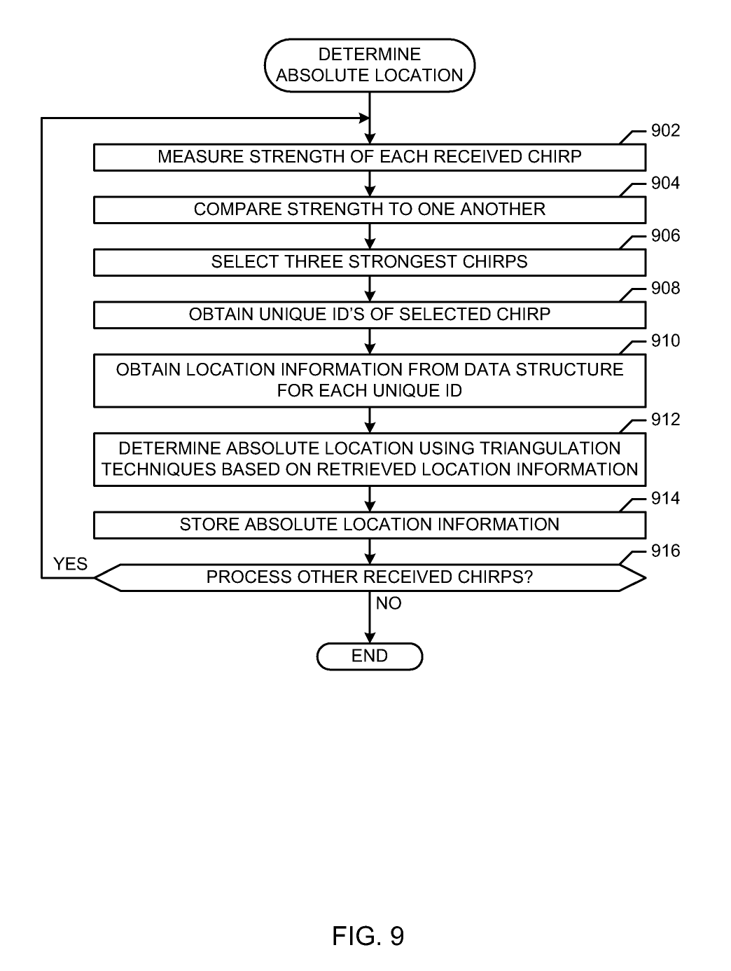

The tag 104 stores representations and/or characteristics of the collected signal emissions in association with a timestamp (block 512). For example, to store a representation of a signal emission, the tag 104 can record the ultrasonic signal emission using a digital audio recorder or encoder (e.g., the digital audio recorder 218 of FIG. 2) and timestamp the recorded ultrasonic signal or chirp. For example, upon detecting the ultrasonic signal emission (or other audio emission) the tag 104 can use an analog-to-digital converter to convert the detected signal emission into a digital pulse-code modulated (PCM) audio format (e.g., a WAV format). The PCM audio information contains relatively large amounts of data to represent the detected signal emission. To reduce the amount of memory space or storage space needed to store a digital representation of the detected signal emission, the tag 104 can use the digital audio recorder 218 to compress the PCM audio information using any suitable digital audio compression standard (e.g., the MP3 standard, the AAC standard, etc.). In this manner, the tag 104 can discard the PCM audio information and store the compressed digital audio representation of the detected signal emission for subsequent processing or analysis. In some example implementations, the tag 104 can convert the received ultrasonic chirps to a human audible range prior to encoding the chips into a digital audio representation. Additionally or alternatively, to store a characteristic of a signal emission, the tag 104 may measure particular parameters of the signal including, for example, signal strength, volume, duration, a unique identification of a corresponding one of the stationary location devices 102, etc. In this manner, the tag 104 can subsequently upload the stored information pertaining to the collected signal emissions to the server 114, and the server 114 or the server 122 at the central facility 116 can determine the absolute locations of the tag 104 based on this information. Determining absolute location information at another system conserves battery power of the tag 104. However, in other example implementations, the tag 104 may be configured to determine its absolute locations. Example methods that can be used to determine the absolute location information are described below in connection with FIGS. 8 and 9.

If the tag 104 determines that signal emissions from the stationary location devices 102 are not available (block 508), then the tag 104 collects dead reckoning information (block 518) that can subsequently be used to generate relative location information by, for example, the server 114 and/or the server 122 at the central facility 116. The dead reckoning information may include, for example, direction information acquired using the digital compass 214 (FIG. 2), motion information collected using the motion sensor(s) 212 (FIG. 2), and/or any other suitable information that may be used in connection with a dead reckoning process. The tag 104 then stores the dead reckoning information with a corresponding timestamp (block 520) indicative of when the tag 104 collected the dead reckoning information. After the tag 104 stores the dead reckoning information (block 520) or after the tag 104 stores the representations and/or characteristics of the signal emissions (block 512), the tag 104 measures and stores the ambient temperature (block 522) and the ambient noise (block 524).

After the tag 104 measures and stores the ambient noise (block 524) or if the tag 104 determines that the timer has not expired (block 504), the tag 104 determines whether it should continue to monitor (block 526). For example, the tag 104 can determine that it should no longer continue to monitor if it detects that the person 106 has returned the tag 104 or has exited the monitored environment 100. If the tag 104 determines that it should continue to monitor (block 526), control is passed back to block 504. Otherwise, if the tag 104 determines that it should not continue to monitor (block 526), the example process of FIG. 5 ends.

FIGS. 6A and 6B depict another example method that may be used to implement the location detection system of FIG. 1 to collect shopper monitoring information including location information indicative of the locations traversed by the person 106 as the person 106 walks through the monitored environment 100. Initially, the tag 104 (e.g., the loaner tag or the personal tag) sets a first timer (e.g., using a timer substantially similar or identical to the timing device 205 of FIG. 2) to an interval indicative of when the tag 104 should generate location information using a dead reckoning process (block 602). The tag 104 also sets a second timer (e.g., using a timer substantially similar or identical to the timing device 205 of FIG. 2) to an interval indicative of when the tag 104 should acquire ultrasonic signal emissions from the stationary location devices 102 (block 604).

The tag 104 then determines whether the first timer has expired (block 606). When the first timer expires (block 606), the tag 104 resets the first timer (block 607) and determines whether it should determine absolute location information (block 608). In the illustrated example, the tag 104 is configured to determine absolute location information whenever possible and the dead reckoning techniques to determine relative location information are used whenever absolute location information cannot be determined. That is to say, under some circumstances (e.g., the tag 104 is located in an area where it is not receiving chirps from any of the stationary location devices 102) the tag 104 may only have the option of using the more error-prone dead reckoning methods. If the tag 104 is in a location in the environment 100 in which it can receive chirps from enough of the stationary location devices 102 to determine absolute location information (block 608), the tag 104 determines that it should determine absolute location information (block 609). Example methods that can be used to determine the absolute location information are described below in connection with FIGS. 8 and 9.

If the tag 104 determines that it cannot determine absolute location information (block 608), then the tag 104 generates relative location information using a dead reckoning process (block 610). For example, the tag 104 uses the last location information (e.g., a previously determined relative location, a previously determined absolute location, a location intermediate the initial location and a current location of the tag 104, an initial location, etc.) generated by the tag 104 or provided to the tag 104 to determine the relative location information at block 610. The tag 104 then stores the relative location information with a corresponding timestamp (block 612) indicative of when the tag 104 generated the relative location information. After the tag 104 stores the relative location information (block 612) or after the tag 104 determines the absolute location information (block 609) or if the first timer has not expired (block 606), the tag 104 determines whether the second timer has expired (block 614) (FIG. 6B). When the second timer expires (block 614), the tag 104 resets the second timer (block 616) and collects signal emissions from one or more of the stationary location devices 102 (block 618). In some example implementations, the tag 104 may be configured to collect and store the three strongest ultrasonic chirps and discard the rest for a particular acquisition instance. In this manner, three signals can be used for triangulation during subsequent analysis.

The tag 104 then timestamps the collected ultrasonic signal information (block 620) and stores the ultrasonic signal information and the corresponding timestamp (block 620) in a memory (e.g., the memory 204 of FIG. 2). For example, the tag 104 can record the ultrasonic signal information using a digital audio recorder or encoder (e.g., the digital audio recorder 218 of FIG. 2) and timestamp the recorded ultrasonic signal or chirp. In some example implementations, the tag 104 can convert the received ultrasonic chirps to a human audible range prior to recording the chips in a digital audio format. The tag 104 then measures and stores the ambient temperature (block 624) and the ambient noise (block 626).

After the tag 104 measures and stores the ambient noise (block 626) or if the tag 104 determines that the second timer has not expired (block 614), the tag 104 determines whether it should determine its absolute location (block 628) based on the received signal emissions. For example, the tag 104 may be configured to determine an absolute location at predetermined intervals based on, for example, time, quantity of relative location determinations, etc. The intervals for determining absolute location information can be specified based on empirical or experimental findings of how much time it takes for relative location information to become too inaccurate to use for market research analysis.

If the tag 104 determines that it should determine absolute location information (block 628), the tag 104 determines absolute location information (block 630). Example methods that can be used to determine the absolute location information are described below in connection with FIGS. 8 and 9. After the tag 104 determines its absolute location or if the tag 104 determines that it should not determine its absolute location, the tag 104 then determines whether it should continue to monitor (block 632). For example, the tag 104 can determine that it should no longer continue to monitor if it detects that the person 106 has turned in the tag 104 or passes an exit door of the monitored environment 100. If the tag 104 determines that it should continue to monitor, control is passed back to block 616. Otherwise, if the tag 104 determines that it should not continue to monitor, the process of FIGS. 6A and 6B ends.

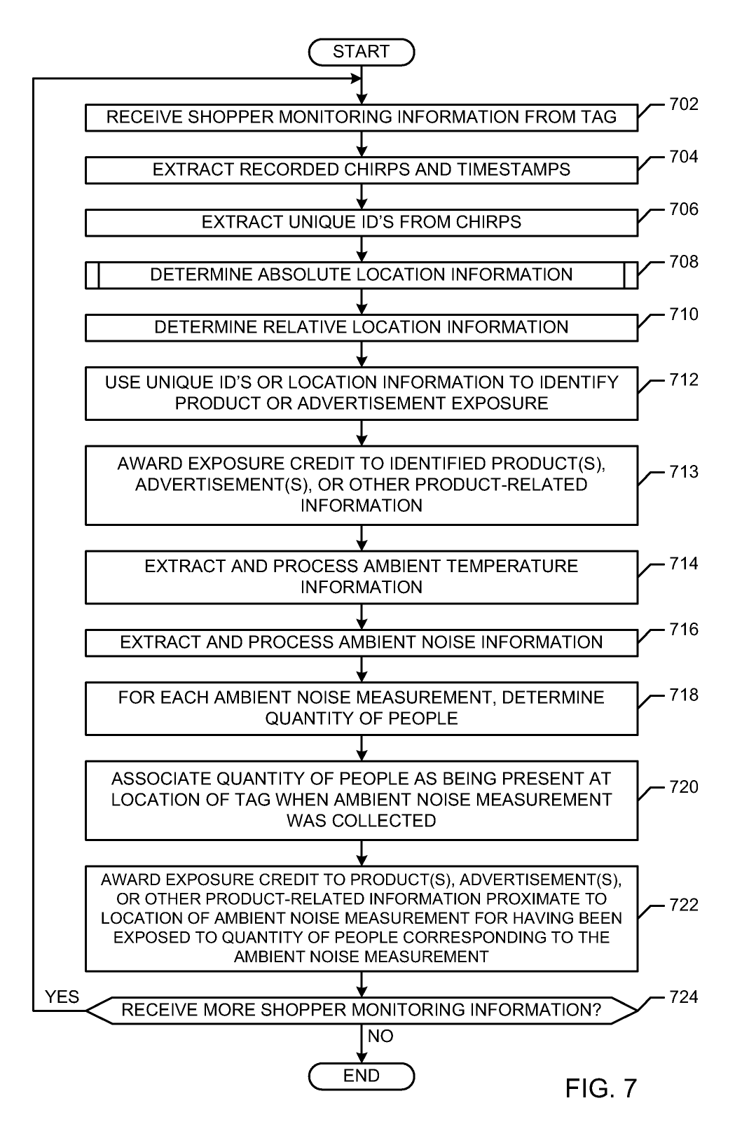

FIG. 7 is a flow diagram illustrating an example method that can be implemented by the server 114 (or the server 122 at the central facility 116) to process the information collected by the tag 104 (FIG. 1) in connection with the example method of FIGS. 4A-4C to determine the locations that the person 106 traversed while walking through the monitored environment 100 (FIG. 1). The example method of FIG. 7 may be used to process chirps from the stationary location devices 102 recorded by the tag 104 to determine location information indicative of the locations traversed by the tag 104 in the environment 100 of FIG. 1. In the illustrated example, the server 114 is configured to determine absolute locations and relative locations of the tag 104 based on information collected by the tag 104. In other example implementations in which the tag 104 has determined absolute location information and/or relative location information, the example method of FIG. 7 can be used to determine supplemental location information (e.g., refined location information having relatively better accuracy). In any case, the server 114 can implement the example method of FIG. 7 to perform smoothing processes and/or other heuristic-based processes (e.g., using the recorded chirps) that are relatively more powerful or complex than processes that the tag 104 can perform.

Initially, the server 114 receives shopper monitoring information from the tag 104 (block 702). For example, the server 114 can receive recorded chirps, ambient temperature information, ambient noise information, and/or any other information related to relative and/or absolute locations of the tag 104 and/or shopper monitoring. The server 114 then extracts the recorded chirps (and/or other characteristics of the recorded chirps) and corresponding timestamps from the received information (block 704) and extracts the unique ID's corresponding to the chirps (block 706). The server 114 then determines absolute location information (block 708) and/or relative location information (block 710) based on the received information. For example, the server 114 can determine absolute location information as described below in connection with FIGS. 8 and 9 and/or relative location information based on the absolute location information using dead reckoning techniques. Additionally or alternatively, the server 114 may extract relative location information generated by the tag 104 and/or absolute location information generated by the tag 104.

The server 114 can perform location determination processes that are relatively more powerful or complex than those implemented by the tag 104 and, thus, the location information determined by the server 114 can be relatively more accurate than location information determined by the tag 104. In some example implementations, the server 114 can be used to decrease the amount of error in any absolute and/or relative location information generated by the tag 104 to increase the accuracy of the location information used to perform market research analysis. An example technique for processing absolute and relative location information involves (1) examining all of the absolute position information (which may be spatially imprecise, but has a maximum bound on the error) generated over a specified period (e.g., the period during which a person wore the tag 104), (2) examining all the dead reckoning-based relative location information (which has a tendency to have increasing errors with time without bound, if not corrected) generated over the same specified period, and (3) merging the absolute and relative location information to achieve an even better estimated path through post-processing.

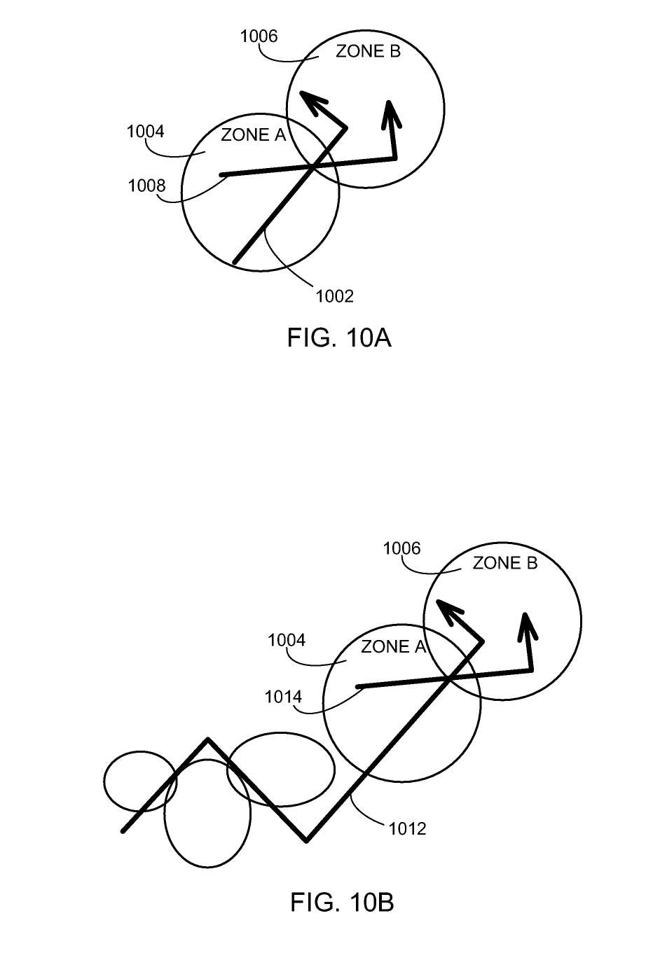

For example, turning to FIGS. 10A and 10B, the server 114 can generate multiple paths that can satisfy the absolute location information and the relative location information For example, FIG. 10A shows a zone presence history indicated by a first path 1002 and a second path 1008 that can be generated based on the absolute location information and relative location information and fit within boundaries of the absolute and relative location information. The paths are shown as moving from zone A 1004 to zone B 1006 (both zones having a relatively large spatial area) at substantially the same time. Based on an analysis of the paths 1002 and 1008, the server 114 can conclude that the tag 104 could have traveled via either of the paths 1002 and 1008. FIG. 10B shows a longer zone presence history relative to FIG. 10A of the tag 104 indicated by two paths 1012 and 1014 generated by the server 114 using the absolute and relative location information associated with the tag 104. The paths 1012 and 1014 are generated using relatively more absolute and relative location information than the paths 1002 and 1008 of FIG. 10A. Unlike the analysis of the paths 1002 and 1008 of FIG. 10A, the server 114 can analyze the paths 1012 and 1014 to conclude that the tag 104 traveled via the path 1012 rather than the path 1014 by determining that the path 1014 does not align with the portions of the path 1012 that are located outside of the zones 1004 and 1006.

Returning to FIG. 7, after determining the path of travel of the shopper or patron (e.g., the person 106 of FIG. 1), the server 114 uses the unique ID's of the recorded chirps and/or the location information to identify the product(s), advertisement(s), or other product-related information that the tag 104 was proximate to as it was moved through the environment 100 (block 712). For example, if the product and advertisement database 118 stores product and advertisement ID's in association with the unique ID's of the stationary location devices 102, the server 114 may access the product and advertisement database 118 to retrieve product and/or advertisement ID's based on the unique ID's obtained via the chirps. Otherwise, if the product and advertisement database 118 stores product and/or advertisement ID's in association with location information indicative of the locations of the stationary location devices 102 in the environment 100, the server 114 retrieves product and advertisement ID's from the product and advertisement database 118 based on the location information generated by the tag 104 and/or the server 114. The server 114 then awards exposure credit to the product(s), advertisement(s), and/or other product-related information identified at block 712 as having been exposed to a person carrying the tag 104 (block 713).

The server 114 then extracts and processes the ambient temperature information (block 714). For example, the server 114 can correlate the ambient temperature and ambient noise information with the shopping habits of a person that carried the tag 104 and/or with statistical information collected from prior studies. The server 114 also extracts and processes the ambient noise information (block 716). In the illustrated example, for each ambient noise measurement, the server 114 determines how many people were present at each location traversed by the tag 104 based on that ambient noise measurement (block 718). For example, the server 114 may use a calibration table storing reference data including previously measured ambient noise levels in association with quantities of persons known to have been present at a location where those ambient noise levels were measured. The server 114 associates the quantity of people determined at block 718 as having been present at a location indicated by a corresponding location (e.g., a relative location, an absolute location, or a location on a path of travel (e.g., the path of travel 1802 or 1804 of FIG. 18) of a shopper generated using relative and/or absolute location information) at which the tag 104 was located when the ambient noise measurement was collected (block 720). The server 114 then credits one or more products, advertisements, or other product-related information (block 722) proximate the location determined at block 720 as having been exposed to the quantities of people determined at block 718. For example, the server 114 may use location information of products, advertisements, etc. in the product and advertisement database 118 (FIG. 1) to determine which products, advertisements, etc. are located proximate the locations associated with the ambient noise measurements.

The server 114 then determines whether it should receive more shopper monitoring information (block 724). For example, the server 114 may receive more shopper monitoring information from the same tag or from another tag. If other more shopper monitoring information is to be received (block 724), control is passed back to block 702. Otherwise, the example method of FIG. 7 ends.

FIG. 8 depicts a flow diagram of an example method that may be implemented using the server 114 and/or the tag 104 to determine the absolute locations (e.g., a first estimated travel path) of the tag 104 based on signal emissions (or chirps) received by the tag 104 from the stationary location devices 102 in the environment 100. The example method of FIG. 8 can be used to determine absolute location information in connection with the operation of block 708 of FIG. 7 and/or the operation of block 630 of FIG. 6B. The example method of FIG. 8 is configured to determine absolute location information based on (1) the unique ID's of the stationary location devices 102 and (2) one or more data structures that store absolute location information of the environment 100 in association with the unique ID's. If the example process of FIG. 8 is implemented using the tag 104, the data structures may be stored in the tag 104. If the example process of FIG. 8 is implemented using the server 114 and/or the server 122 at the central facility 116 of FIG. 1, the data structures may be stored in the server 114 and/or the server 122 of the central facility 116. For purposes of discussion, the example process is described as being performed by the server 114.

Initially, the server 114 retrieves a set of chirp data (block 804). In the illustrated example, the set of chirp data may include the characteristics, recordings, and/or other data representative of a plurality of chirps detected by the tag 104 at a particular time and location in the environment 100 at, for example, block 510 of FIG. 5. The server 104 then measures the strength (e.g., volume, signal power, etc.) of each chirp (block 806) represented by the retrieved chirp data. The server 104 then compares the strengths to one another (block 808) and selects the strongest chirp (block 810).

The server 114 then extracts a unique ID from the selected chirp (block 812) and obtains absolute location information from a data structure based on the extracted unique ID (block 814). For example, the server 114 may use the unique ID to retrieve absolute location information of the stationary location device corresponding to the unique ID from a data structure stored in the server 114. The server 114 then stores the absolute location information (block 816). The server 114 may use the absolute location during a next process to determine relative location information. For example, the server 114 may set a bit associated with the absolute location information that indicates that the server 114 should use the absolute location information the next time the server 114 determines a relative location of the tag 104. The server 114 then determines whether it should process another set of chirp data (block 818). If other chirp data remains to be processed (block 818), control is passed back to block 804. Otherwise, the example method of FIG. 8 ends.

FIG. 9 is a flow diagram illustrating another example method that may be implemented using the server 114 and/or the tag 104 to determine absolute location(s) of the tag 104 based on signal emissions (or chirps) received from the stationary location devices 102 in the environment 100. The example method of FIG. 9 is configured to determine absolute location information using triangulation techniques. The example method of FIG. 9 can be used to implement the operation of block 708 of FIG. 7 and/or the operation of block 630 of FIG. 6B. Initially, the server 114 retrieves and/or measures the strength (e.g., volume, signal power, etc.) of each chirp received at a particular time (block 902). For example, the server 114 can measure the strength of each chirp recording stored at block 512 (FIG. 5) during a particular signal emission collection time. Alternatively, the server 114 can retrieve strength values stored by the tag 104 at block 512 for each of the received chirps. The server 114 then compares the strengths of the received chirps to one another (block 904) and selects the three strongest chirps (block 906) based on the comparison. Alternatively, in some example implementations, the server 114 can select more or fewer chirps to use for determining the absolute location of the tag 104 using, for example, triangulation. In some example implementations in which the tag 104 measures the strength of and selects a predetermined number of chirps, the operations of blocks 902 and 904 may be skipped in connection with the example process of FIG. 9.

The server 114 then obtains unique ID's based upon the selected chirps (block 908) and obtains absolute location information from a data structure for each of the unique ID's (block 910). For example, the server 114 may use the unique ID's to retrieve corresponding absolute location information from a data structure stored in or communicatively coupled to the server 114 that stores the unique ID's of the stationary location devices 102 in association with the location of the stationary location devices 102 in the environment 100. The server 114 then determines the absolute location of the tag 104 using triangulation techniques (block 912) based on the retrieved location information of the ones of the stationary location devices 104 corresponding to the selected strongest chirps. The server 114 then stores the absolute location information (block 914). In some example implementations, the server 114 may use the absolute location during a next process to determine relative location information. The server 114 then determines whether it should process other received chirps (block 916). If other chirps remain to be processed (block 916), control is passed back to block 902. Otherwise, the example method of FIG. 9 ends.

Although the above description refers to the flowcharts as being representative of methods, those methods may be implemented entirely or in part by executing machine readable instructions. Therefore, the flowcharts are representative of methods and/or machine readable instructions.

FIG. 12 is a block diagram of the example point of service system 111 of FIGS. 1 and 11. The example point of service system 111 may be implemented using any desired combination of hardware, firmware, and/or software. For example, one or more integrated circuits, discrete semiconductor components, and/or passive electronic components may be used. Additionally or alternatively, some or all of the blocks of the example point of service system 111, or parts thereof, may be implemented using instructions, code, and/or other software and/or firmware, etc. stored on a machine accessible medium that, are executed by, for example, a processor system (e.g., the example processor system 1910 of FIG. 19).

To enable a market research person to enter demographic/personal information and/or basic characteristic information into the point of service system 111, the point of service system 111 is provided with a user interface 1202. The user interface 1202 may be implemented using a display, a keyboard, a mouse, and/or a touch screen. To store demographic/personal information and/or basic characteristic information, the example system 111 is provided with a demographic information database 1204. To store and retrieve data to/from the demographic information database 1204, the system 111 is provided with a data interface 1206.

To communicate the demographic/personal information, the basic characteristic information, and/or the tag identifications to the server 114 (FIG. 1), the system 111 is provided with a communication interface 1208. The communication interface 1208 may be implemented using any wired or wireless communication interface as discussed above. To retrieve tag identifications, the system 111 is provided with an identification scanner interface 1210. In the illustrated example, the identification scanner interface 1210 is configured to be coupled to the barcode scanner 1102 of FIG. 11 to scan barcodes attached to tags to retrieve the identification of each tag carried by a patron during a shopping visit. The system 111 may store the tag identifications in association with corresponding demographic/personal information and/or basic characteristic information in the demographic information database.

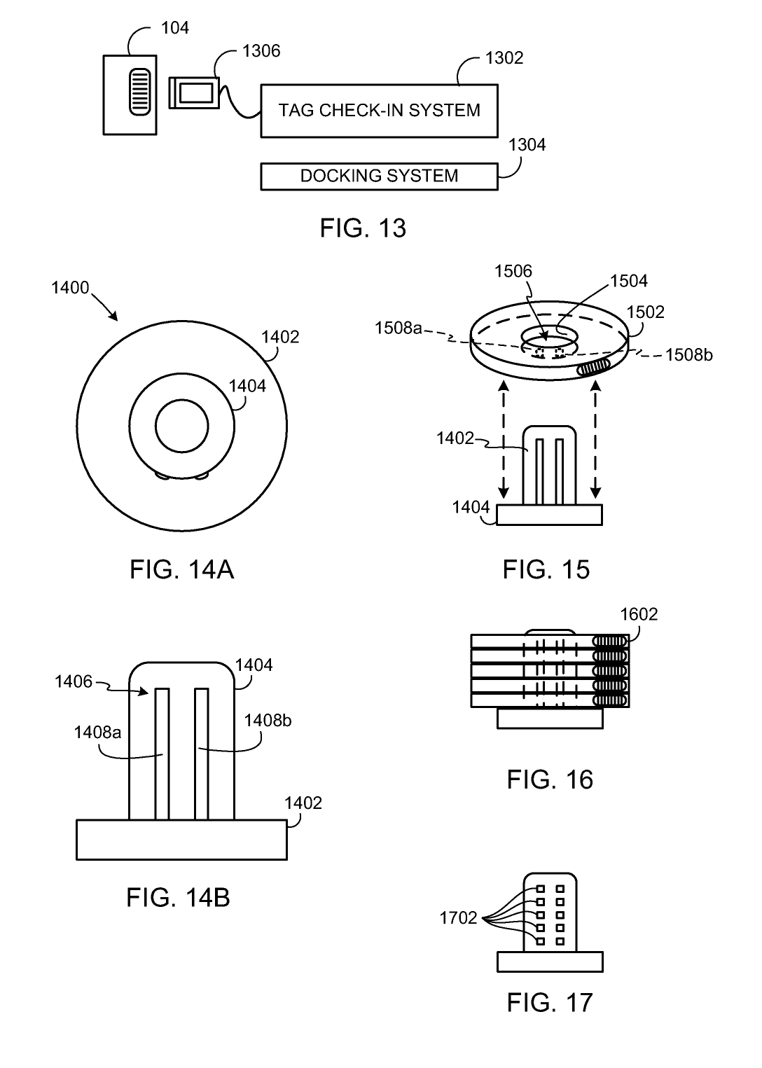

FIG. 13 depicts an example tag check-in system 1302 and an example docking system 1304 that can be placed at a check-out counter of a commercial establishment (e.g., a retail or wholesale establishment) such as the monitored environment 100. The tag check-in system 1302 can be used to implement the tag check-in systems 132 of FIG. 1, and the docking system 1304 can be used to implement the docking stations 134 of FIG. 1. The tag check-in system 1302 and the docking system 1304 can be communicatively coupled to the server 114 (FIG. 1). Additionally or alternatively the tag check-in system 1302 and the docking system 1304 can be communicatively coupled to the server 122 of the central facility 116 directly or via the server 114, and the server 122 of the central facility 116 can be communicatively coupled to a plurality of other tag check-in systems and docking systems in other monitored environments. The tag check-in system 1302 can be configured to check-in tags when shoppers return their borrowed tags at the end of their shopping visit. The docking system 1304 includes communication interfaces (e.g., radio frequency (RF) interfaces, mechanical contact interfaces, infrared interfaces, etc.) to communicatively couple tags to the server 114 to communicate shopper monitoring information (e.g., the shopper monitoring information collected at block 446) to the server 114.

As shown, the tag check-in system 1302 is communicatively coupled to a barcode scanner 1306. In some example implementations, when a shopper returns the tag 104, a cashier attendant can use the barcode scanner 1306 to scan a barcode of the tag 104 to retrieve the identification of the tag 104. In other example implementations, the barcode scanner 1306 can be mounted to the docking system 1304 so that when the cashier attendant places the tag 104 on the docking system 1304, the barcode scanner 1306 can scan the identification of the tag 104. The identification can be used to indicate that the tag 104 has been returned and that the shopper has finished shopping.

FIGS. 14A and 14B depict an example docking station 1400 that may be used to implement the example docking system 1304 of FIG. 13. For example, the example docking system 1304 of FIG. 13 can be equipped with a plurality of docking stations substantially similar or identical to the docking station 1400 to be enmeshed with tags (e.g., the tag 104 of FIG. 1) and receive information from the tags. In the illustrated example, the docking station 1400 includes a base 1402 and a tag receiver column or shaft 1404 in the form of a cylindrical protrusion extending from the base 1402. The tag receiver column 1404 is configured to receive tags having apertures formed therethrough. For example, as shown in FIG. 15, a tag 1502 having an aperture 1504 formed therethrough slides onto the docking station 1400 so that the tag receiver column 1404 slides through the aperture 1504.

The tag 1502 may be used to implement the tags 104 and 108 (FIG. 1). In the illustrated example, the tag 1502 is implemented using a toroid-shaped form-factor (e.g., a toroid-shaped housing or toroid-shaped body). Other shaped form-factors with or without apertures formed therethrough may alternatively be used including, for example, square-shaped form-factors, triangle-shaped form-factors, etc. Also in the illustrated example, the tag receiver column 1404 and the aperture 1504 of the tag 1502 are implemented using circular shapes. In other example implementations, differently shaped columns and apertures (e.g., square shapes, triangle shapes, etc.) may be used instead to implement the tag receiver column 1404 and the aperture 1504.

As shown in FIGS. 14A, 14B, and 15, the tag receiver column 1404 includes a physical communication interface 1406 including contact strips 1408a and 1408b extending along a length of the tag receiver column 1404. To communicatively couple the tag 1502 with the tag receiver column 1404, the tag 1502 is provided with a communication interface 1506 including contact pads 1508a and 1508b on an inner surface of the aperture 1504. Each of the contact pads 1508a-b is configured to communicatively engage a respective one of the contact strips 1408a and 1408b of the tag receiver column 1404 when the tag 1502 is placed onto the tag receiver column 1404 by capturing the tag receiver column 1404 in the aperture 1504. That is, the tag receiver column 1404 receives the tag 1502 by penetrating and/or extending through the aperture 1504 of the tag 1502. In this manner, when the tag 1502 and the docking station 1400 are in enmeshment, the tag 1502 can upload the shopper monitoring information to the server 114 via the contact strips 1408a-b. The interfaces 1406 and 1506 can be coupled to serial communication ports (not shown) in the tag receiver column 1404 and the tag 1502 to enable serial data communication between the tag 1502 and the server 114. In some example implementations, the serial communication ports can be implemented using a multi-node serial interface such as, for example, the I²C Bus® two-wire serial interface by Philips Electronics N.V. Corporation of Eindhoven, Netherlands which can be configured to operate at data transfer rates from 10 kilobits per second in low-speed mode to 3.4 megabits per second in high-speed mode. Multi-node serial interfaces such as the I²C Bus® interface use a communication arbitration scheme to enable coupling a plurality of devices (e.g., multiple tags 1502) to the same physical wires or mechanical interface contacts (e.g., the contact strips 1408a and 1408b) without creating bus contentions or collisions as the devices transfer their information. In other example implementations, the physical communication interface 1406 may be implemented using a plurality of separate mechanical interface contact pads 1702 as shown in FIG. 17. In this manner, each tag stacked on the tag receiver column 1404 can be communicatively coupled to a respective one of the contact pads 1702 to communicate its information to the server 114. Although only two contact pads 1702 are shown for each tag 1502, more contacts pads per tag may be provided to suit the needs of a particular communication interface hardware and protocol to be used (e.g., an RS-232 interface, a universal serial bus (USB) interface, etc.).

As shown in FIG. 16, the docking station 1400 is configured to simultaneously receive a plurality of tags that can be stacked on one another. The stacking configuration minimizes space requirements while maximizing the number of tags that can be collected from patrons. Each of the tags is provided with a unique identifier 1602, which is implemented using a barcode label in the illustrated example. In the illustrated example, the docking station 1400 is also configured to charge a rechargeable battery in the tag 1502 via, for example, the contact strips 1408a-b and the contact pads 1508a-b or separate interfaces.

FIG. 19 is a block diagram of an example processor system 1910 that may be used to implement the apparatus and methods described herein. As shown in FIG. 19, the processor system 1910 includes a processor 1912 that is coupled to an interconnection bus 1914. The processor 1912 includes a register set or register space 1916, which is depicted in FIG. 19 as being entirely on-chip, but which could alternatively be located entirely or partially off-chip and directly coupled to the processor 1912 via dedicated electrical connections and/or via the interconnection bus 1914. The processor 1912 may be any suitable processor, processing unit or microprocessor. Although not shown in FIG. 19, the system 1910 may be a multi-processor system and, thus, may include one or more additional processors that are identical or similar to the processor 1912 and that are communicatively coupled to the interconnection bus 1914.

The processor 1912 of FIG. 19 is coupled to a chipset 1918, which includes a memory controller 1920 and an input/output (I/O) controller 1922. As is well known, a chipset typically provides I/O and memory management functions as well as a plurality of general purpose and/or special purpose registers, timers, etc. that are accessible or used by one or more processors coupled to the chipset 1918. The memory controller 1920 performs functions that enable the processor 1912 (or processors if there are multiple processors) to access a system memory 1924 and a mass storage memory 1925.

The system memory 1924 may include any desired type of volatile and/or non-volatile memory such as, for example, static random access memory (SRAM), dynamic random access memory (DRAM), flash memory, read-only memory (ROM), etc. The mass storage memory 1925 may include any desired type of mass storage device including hard disk drives, optical drives, tape storage devices, etc.

The I/O controller 1922 performs functions that enable the processor 1912 to communicate with peripheral input/output (I/O) devices 1926 and 1928 and a network interface 1930 via an I/O bus 1932. The I/O devices 1926 and 1928 may be any desired type of I/O device such as, for example, a keyboard, a video display or monitor, a mouse, etc. The network interface 1930 is communicatively coupled to the network 124 and may be, for example, an Ethernet device, an asynchronous transfer mode (ATM) device, an 802.11 device, a DSL modem, a cable modem, a cellular modem, etc. that enables the processor system 1910 to communicate with another processor system.

While the memory controller 1920 and the I/O controller 1922 are depicted in FIG. 19 as separate blocks within the chipset 1918, the functions performed by these blocks may be integrated within a single semiconductor circuit or may be implemented using two or more separate integrated circuits.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method of monitoring a person's activity, the method comprising:
receiving via a portable device a first signal from a first one of a plurality of stationary devices positioned throughout a monitored environment;
determining a first stationary device location of the first stationary device based on the first signal;
determining absolute location information indicative of a first portable device location of the portable device based on the first stationary device location;
generating navigational sensing information via the portable device; and
determining relative location information based on the absolute location information and the navigational sensing information, wherein the relative location information is indicative of a second portable device location of the portable device.

2. A method as defined in claim 1, wherein the navigational sensing information is at least one of motion information or direction information.

3. A method as defined in claim 1, further comprising receiving via the portable device a second signal from a second one of the plurality of stationary devices and determining the absolute location information indicative of the first portable device location based on the first and second signals.

4-8. (canceled)

9. A method as defined in claim 1, further comprising determining whether a person was exposed to at least one of a product or an advertisement based on at least one of the absolute location information or the relative location information.

10. A method as defined in claim 9, wherein determining whether the person was exposed to the at least one of the product or the advertisement comprises comparing the at least one of the absolute location information or the relative location information to location information stored in a database in association with an identifier indicative of the at least one of the product or the advertisement.

11-16. (canceled)

17. A method as defined in claim 1, further comprising determining at least one characteristic of the first signal, storing a representation of the at least one characteristic, and discarding the first signal.

18. A method as defined in claim 17, wherein the at least one characteristic is one of a signal strength or a unique identifier of the first stationary device.

19-23. (canceled)

24. A method as defined in claim 1, further comprising using the absolute location information to correct a path of travel generated using other relative location information generated prior to determining the absolute location information.

25-28. (canceled)

29. A method as defined in claim 1, further comprising retrieving an identifier from the first signal corresponding to the first stationary device and determining the first location of the first stationary device based on the identifier.

30. A method as defined in claim 29, wherein the identifier is one of a location coordinate or a unique identification of the first stationary device.

31. An apparatus to monitor a person's activity, the apparatus comprising:
a signal receiver to receive a first signal from a first one of a plurality of stationary devices positioned throughout a monitored environment;
a processor to determine absolute location information indicative of a first portable device location of the portable device based on a first location associated with the first signal; and
a navigational data sensor to generate navigational sensing information, wherein the processor is further to determine relative location information based on the absolute location information and the navigational sensing information, and wherein the relative location information is indicative of a second portable device location of the portable device.

32. An apparatus as defined in claim 31, wherein the first location associated with the first signal is a location of the first stationary device.

33. An apparatus as defined in claim 31, wherein the navigational data sensor is at least one of a motion sensor or a compass.

34-44. (canceled)

45. An apparatus as defined in claim 31, further comprising an audio encoder to generate an audio representation of the first signal and a memory to store the audio representation of the first signal.

46-47. (canceled)

48. An apparatus as defined in claim 31, further comprising a housing containing the processor, the housing having a toroid-shaped form factor.

49-51. (canceled)

52. An apparatus as defined in claim 31, wherein the processor determines the relative location information by determining the relative location information using a dead reckoning process.

53-63. (canceled)

64. A system to monitor a person's activity, the system comprising:
a portable device having a toroid-shaped body defining an aperture extending therethrough, the body having a first communication interface to communicate information; and
a docking station having a base and a protrusion extending therefrom to receive the toroid-shaped body by penetrating the aperture of the portable device, wherein the docking station includes a second communication interface to be communicatively coupled to the first communication interface of the portable device to receive the information from the portable device.

65. A system as defined in claim 64, wherein the docking station is to receive the portable device and a second portable device in a stacked configuration, and wherein the toroid-shaped body further includes a first planar surface to engage the base of the docking station and a second planar surface to engage the second portable device.

66. (canceled)

67. A system as defined in claim 64, wherein the first communication interface of the portable device is a mechanical contact positioned on an inner surface of the body within the aperture.

68. (canceled)

69. A system as defined in claim 64, wherein the information is associated with location information indicative of a path of travel of the portable device.

70. (canceled)

71. A system to monitor a person's activity, the system comprising:
a first portable device comprising a body having a first communication interface to communicate first information; and
a docking station having a base to receive the first portable device and at least a second portable device in a stacked configuration, wherein the docking station includes a second communication interface to be communicatively coupled to the first communication interface of the first portable device to receive the first information from the first portable device and to be communicatively coupled to a third communication interface of the second portable device to receive second information from the second portable device.

72. A system as defined in claim 71, wherein the first information is associated with first location information indicative of a first path of travel of the first portable device, and wherein the second information is associated with second location information indicative of a second path of travel of the second portable device.

73-75. (canceled)

76. A system to monitor a person's activity, the system comprising:
a portable device to generate first information representative of a first signal received from a first one of a plurality of stationary devices positioned throughout a monitored environment and generate navigational sensing information via a navigational data sensor; and
a processor system to receive the first information and the navigational sensing information from the portable device and determine absolute location information indicative of a first portable device location of the portable device based on the first information and determine relative location information based on the absolute location information and the navigational sensing information, wherein the relative location information is indicative of a second portable device location of the portable device.

77. A system as defined in claim 76, wherein the first information is indicative of a location of the first one of the plurality of stationary devices.

78-81. (canceled)

82. A system as defined in claim 76, wherein the navigational data sensor is at least one of a motion sensor or a compass.

83. (canceled)
